(19) United States
(12) Patent Application Publication
(10) Pub. No.: US 2025/0301205 A1
(43) Pub. Date: Sep. 25, 2025

(54) SYSTEMS, METHODS, AND APPARATUSES FOR DYNAMIC CONTENT EXTRACTION IN VISUAL MEDIA CONTENT

(71) Applicant: Assurant, Inc., New York, NY (US)

(72) Inventors: Biju Nair, Long Grove, IL (US); Brandon Johnson, Nashville, TN (US)

(21) Appl. No.: 19/086,732

(22) Filed: Mar. 21, 2025

Related U.S. Application Data
(60) Provisional application No. 63/568,768, filed on Mar. 22, 2024.

(51) Int. Cl. H04N 21/81; G06N 20/00; G06V 10/764; G06V 20/40; H04N 21/44; H04N 21/845

(52) U.S. Cl. CPC H04N 21/8133; G06N 20/00; G06V 10/764; G06V 20/46; H04N 21/44008; H04N 21/8456

(57) ABSTRACT

Various embodiments are directed to apparatuses, methods, computer readable media, computer program products, and systems related to dynamic content extraction in visual media content. In some embodiments the system for dynamic content extraction in visual media content may comprise one or more processors and at least one non-transitory memory comprising instructions that, with the one or more processors, cause the system to receive a segment selection indication associated with visual media content; identify a segment of the visual media content based on temporal indicator associated with the segment selection indication; extract a content data object from at least one portion of the segment of the visual media content; generate a relevance data object based on the content data object; and cause display of the relevance data object to a user.

### CROSS-REFERENCE TO RELATED APPLICATIONS

This application claims priority to U.S. Provisional Patent Application No. 63/568,768 entitled “SYSTEMS, METHODS, AND APPARATUSES FOR DYNAMIC CONTENT EXTRACTION IN VISUAL MEDIA CONTENT,” filed Mar. 22, 2024, which is incorporated herein by reference in its entirety.

### FIELD OF THE INVENTION

The present disclosure relates, generally, to systems, methods, and apparatuses for dynamic content extraction. Example embodiments are directed to system, methods, and apparatuses, for dynamic content extraction in visual media content.

### BACKGROUND

Visual media content, including streaming content, is often viewed through devices like television, smartphones, tablets, personal computers, etc. Applicant has identified a number of challenges associated with extracting and analyzing content from visual media content, particularly without interruption to the underlying visual media content in some circumstances. Through applied effort, ingenuity, and innovation many deficiencies of existing systems have been solved by developing solutions that are in accordance with the embodiments as discussed herein, many examples of which are described in detail herein.

### BRIEF SUMMARY

In general, embodiments of the present disclosure provided herein may relate to dynamically content extraction in visual media content. Other implementations for content extraction will be, or will become, apparent to one with skill in the art upon examination of the following figures and detailed description. It is intended that all such additional implementations be included within this description be within the scope of the disclosure and be protected by the following claims.

Various embodiments are directed to apparatuses, methods, computer readable media, computer program products, and systems related to dynamic content extraction in visual media content. Various embodiments may include a system for dynamic content extraction in visual media content, the system comprising one or more processors and at least one non-transitory memory comprising instructions that, with the one or more processors, cause the system to: receive a segment selection indication associated with visual media content; identify a segment of the visual media content based on temporal indicator associated with the segment selection indication; extract a content data object from at least one portion of the segment of the visual media content; generate a relevance data object based on the content data object; and cause display of the relevance data object to a user. In various embodiments, the segment of the visual media content includes a visual representation of a content object. In various embodiments, the temporal indicator comprises a timestamp associated with the content object visually rendered in the visual media content. In various embodiments, the segment comprises one or more frames of the visual media content and the temporal indicator comprises a frame identifier associated with the content object visually rendered in the visual media content. In various embodiments, the content data object comprises a content object identifier for the content object visually rendered in the visual media content. In various embodiments, the content data object comprises an image of the content object visually rendered in the visual media content. In various embodiments, extracting the content data object comprises capturing an image of the content object visually rendered in the visual media content; and performing image analysis on the captured image to identify the content object visually rendered in the visual media content. In various embodiments, the segment selection indication further comprises a spatial segment indicator, and the segment is identified based on the temporal indicator and the spatial segment indicator. In various embodiments, the relevance data object is generated using a machine learning relevance model analyzing the content data object and contextual data associated with the user. In various embodiments, the relevance data object is generated using a machine learning relevance model analyzing the content data object and user data.

Various embodiments may include a computer implemented method for dynamic content extraction in visual media content, the method comprising: receiving a segment selection indication associated with visual media content; identifying a segment of the visual media content based on temporal indicator associated with the segment selection indication; extracting a content data object from at least one portion of the segment of the visual media content; generating a relevance data object based on the content data object; and causing display of the relevance data object to a user. In various embodiments, the segment of the visual media content includes a visual representation of a content object. In various embodiments, the temporal indicator comprises a timestamp associated with the content object visually rendered in the visual media content. In various embodiments, the segment comprises one or more frames of the visual media content and the temporal indicator comprises a frame identifier associated with the content object visually rendered in the visual media content. In various embodiments, the content data object comprises a content object identifier for the content object visually rendered in the visual media content. In various embodiments, the content data object comprises an image of the content object visually rendered in the visual media content. In various embodiments, extracting the content data object comprises capturing an image of the content object visually rendered in the visual media content; and performing image analysis on the captured image to identify the content object visually rendered in the visual media content. In various embodiments, the segment selection indication further comprises a spatial segment indicator, and the segment is identified based on the temporal indicator and the spatial segment. In various embodiments, the relevance data object is generated using a machine learning relevance model analyzing the content data object and contextual data associated with the user. In various embodiments, the relevance data object is generated using a machine learning relevance model analyzing the content data object and user data.

### BRIEF DESCRIPTION OF THE DRAWINGS

Reference will now be made to the accompanying drawings, which are not necessarily drawn to scale, and wherein:

FIG. 1 illustrates an example system environment within which at least some embodiments of the present disclosure may operate;

FIG. 2 illustrates a block diagram of an apparatus that may be specifically configured, within which at least some embodiments of the present disclosure may operate;

FIG. 3 is a data flow diagram showing example data structures for dynamic content extraction in visual media content in accordance with at least some embodiments of the present disclosure;

FIG. 4 illustrates an example flowchart depicting operations for dynamic content extraction in accordance with at least some example embodiments of the present disclosure;

FIG. 5 illustrates an example network architecture for an example implementation of a dynamic content extraction system in accordance with at least some embodiments of the present disclosure;

FIG. 6 illustrates an example data flow for the example implementation of FIG. 5 in accordance with at least some embodiments of the present disclosure;

FIG. 7 illustrates a block diagram of an example data flow related to extracting content data objects in accordance with at least some embodiments of the present disclosure.

FIG. 8 illustrates an operational example of a relevance data object displayed on a display in accordance with at least some embodiments of the present disclosure;

FIG. 9A is a data flow diagram showing example data structures for dynamic content extraction in visual media content in accordance with at least some embodiments of the present disclosure;

FIG. 9B is a data flow diagram showing example data structures for dynamic content extraction in visual media content in accordance with at least some embodiments of the present disclosure; and

FIG. 10 illustrates an operational example of initiating a dynamic content extraction process in accordance with at least some embodiments of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout. While values for dimensions of various elements may be disclosed, the drawings may not be to scale.

The words “example,” or “exemplary,” when used herein, are intended to mean “serving as an example, instance, or illustration.” Any implementation described herein as an “example” or “exemplary embodiment” is not necessarily preferred or advantageous over other implementations.

### Overview

Visual media content often includes various content objects which may be of interest to a user. Attempting to follow-up on this interest may require interrupting the visual media content and an iterative, imprecise search process to identify information associated with the content object. In some such instances, the information associated with the content object is deliverable only by again interrupting the visual media content (e.g., by concatenating the visual media content with the information, such as attaching the information to the end of the visual media content or during a break in the visual media content). Embodiments of the present disclosure relate to dynamic content extraction associated with content objects in visual media content and/or delivery of information associated with the extracted content objects (e.g., relevance data objects) without interrupting the visual media content. In some embodiments, the visual media content may not be individually interruptible (e.g., over-the-air broadcasts) by at least some embodiments described herein, and in such embodiments, the content may be extracted dynamically during presentation of the visual media content without interrupting or otherwise preventing viewing of the entirety of the visual media content.

For example, the present disclosure relates to extracting content (e.g., objects or information related to objects and/or other features) from visual media content shown on a display. In some embodiments, the content may be extracted during presentation of the visual media content, in some instances, without interrupting (e.g., pausing, obscuring, etc.) the visual media content. A dynamic content extraction process may be initiated according to various embodiments of the present disclosure in response to a segment selection indication being received from a segment selection generator (e.g., one or more user devices displaying and/or interacting with the visual media content or devices displaying the visual media content). Such segment selection indication may be generated in response to certain user interaction that indicates the user's interest in a content object visually rendered in the visual media content. For example, a user may trigger a segment selection indication by pressing a button on a first user device (e.g., a remote control) that may be received at a second user device (e.g., a smart television), which may generate a segment selection indication based on the user interaction and the signal from the first user device.

Example embodiments may execute a dynamic content extraction in response to this segment selection indication in real-time by identifying a segment of the visual media content that corresponds to the segment selection indication. For example, the system may be configured to identify a timestamp and/or frame that matches the time of the user interaction and/or signal from the first user device in the above-noted example. The segment may also include spatial information, such as a coordinate location associated with the user interaction and/or signal from the first user device in the above-noted example.

Based on the segment of visual media content identified by the user, the dynamic content extraction system may extract a content data object representing at least a portion of the segment (e.g., a frame, a portion of a frame, a description or other data associated with the frame or portion of the frame, etc.), again in some embodiments while the visual media content continues uninterrupted for the user. The extraction and generation of the content data object may, in some instances, be performed by capturing or generating image data associated with the segment and/or by performing image analysis on the segment.

The system may, still during presentation of the visual media content, apply the content data object to a model, algorithm, or application as described herein (e.g., a machine learning relevance model) to generate and provide a relevance data object comprising contextually relevant information to the user (e.g., in real time or otherwise during the display of the uninterrupted visual media content in some embodiments).

For example, a user watching visual media content, such as streaming content of an episode of a television series, on a display of a television or other user device may come across a content object visually rendered in the visual media content that is of interest to the user. For example, the user may come across a character wearing a jacket or sporting an accessory that the user likes and which the user would like to obtain relevant information about. Via the dynamic content extraction process described herein, the user can, in real-time, access information about the content object of interest (e.g., jacket or accessory) by interacting with the display (e.g., by clicking on the visual representation of the jacket or accessory rendered on the display via a remote control, such as an IR-remote, smart connected device, or other user device). In response to the user interaction, a segment selection indication configured to trigger a dynamic content extraction process as described herein may be generated and a relevance data object corresponding to the segment selection indication generated and provided to the user in real-time.

Example embodiments may execute the dynamic content extraction process concurrently with the visual media content. Example embodiments may allow for the user to continue streaming the visual media content without interruption. Example embodiments may allow the user to switch the interaction to another user device (e.g., from the television to a connected smart device) or continue interacting with the display concurrently with the streaming of the visual media content or while the visual media content is paused.

Example embodiments may curate content data in a repository, the content data may be associated with content objects visually rendered or renderable in the visual media content (e.g., the actual jacket or accessory worn in the television series in the above example) or content data associated with similar content object (e.g., jackets or accessories having similar attributes, such as via a calculated relevance score, to the actual jacket or accessory worn in the television series in the above example). Example embodiments may store the curated content data in a content data repository and leverage the content data with the extracted content data object to generate a relevance data object for a user. Example embodiments may gather the content data from various sources including, for example, content object providers (e.g., manufacturers, visual media content generators, or the like) and may provide access for the various data sources to update a content repository comprising the content data, such that most recent content data may be leveraged to generate a relevance data object for a user.

Example embodiments may leverage one or more of a variety of techniques to generate the content data object and/or relevance data object including, but not limited to matching techniques, image recognition, natural language processing, and/or machine learning in accordance with embodiments disclosed herein. Example embodiments may leverage contextual data (e.g., consumer behavior, industry trends, social media engines feeds, and/or other information streams) obtained via or more data sources to adapt offers based at least in part on the contextual data. Embodiments of the systems, apparatuses, and methods discussed herein may cause display of the relevance data object on one or more user devices. Example embodiments may cause display of the relevance data object concurrently with the visual media content being rendered on a user device.

Various technical improvements will be appreciated from the present disclosure. For example, embodiments of the present disclosure provide for dynamic content extraction from a visual media content stream without interrupting the visual media content, during extraction and/or during presentation of a relevance data object. The dynamic content extraction processes and systems described herein may also be retrofit with existing visual media content streams and existing displays without requiring the control or customization functions of more modern streaming platforms. The dynamic content extraction processes and systems described herein may similarly provide a universal framework and platform that is visual media content and/or display agnostic, such that the processes and systems may be used to unify and/or centralize content extraction across multiple devices, systems, and media content platforms.

Various additional technical improvements facilitated by one or more embodiments discussed herein include curating content data and leveraging the content data to provide contextually relevant data to a user in real-time. For example, users may be enabled to instantly or near instantly access information associated with content objects seen on a display via an intuitive input and seamless backend analysis. By providing contextually relevant data to a user in real-time, various embodiments of the present disclosure obviate the need for the user to query various search engines in order to obtain the desired information. Likewise, the visual media content provider system may save processing resources and memory space by not generating or inserting data objects (e.g., periodic relevance data objects not prompted by the user) that are not prompted by the user interaction, allowing for minimized processing and memory waste on relevance data object delivery and allowing more dynamic and customized relevance data object delivery for individual users. The processor and memory usage of visual media content generation systems may also be reduced by overlaying the dynamic content extraction system on existing visual media content provider systems and handling the processing of dynamic content extraction on an as needed basis and an individualized basis in a modular manner that does not affect the underlying visual media content or display thereof. This in turn, facilitates efficient computing resource usage.

By maintaining a content data repository comprising content data obtained from content object providers and providing access for the content object providers to update the content data repository, embodiments of the present disclosure improve the accuracy and reduce the memory usage of the relevance data objects.

Further, by providing a relevance data object in response to a segment selection indication based on user input/user interaction and leveraging contextual data associated with the user, various embodiments provide individualized relevance data objects, which optimize computer resource usage.

### Definitions

In some embodiments, some of the operations above may be modified or further amplified. Furthermore, in some embodiments, additional optional operations may be included. Modifications, amplifications, or additions to the operations above may be performed in any order and in any combination.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, and/or the like. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, a “computer-readable storage medium,” refers to a physical storage medium (e.g., volatile, or non-volatile memory device), and may be differentiated from a “computer-readable transmission medium,” which refers to an electromagnetic signal.

As used herein, the terms “data structure,” “data object,” or “data set” refer interchangeably to data capable of being transmitted, received, and/or stored.

As used herein, the terms “application,” “software application,” “app,” “computer program,” “service,” or similar terms refer to a computer program or group of computer programs designed to perform coordinated functions, tasks, or activities. Such computer programs may be operated by or for the benefit of a user or group of users. An application may be configured to provide access to one or more services provided by an entity. For example, an application may be configured to provide access to services provided by visual media content provider systems. An application may run on a server or group of servers, such as, but not limited to, web servers and application servers. In some embodiments, an application may be run on or across one or more other computing devices (e.g., user devices). For example, an application may be configured to be accessed via a web browser, a dedicated client running on a user device, and/or the like. In some examples, an application may be configured for use by and interaction with one or more local, networked or remote computing devices.

As used herein, the term “user device” refers a physical electronic device that may be used by a user for any of a variety of purposes including, but not limited to, one or more of sending and/or receiving signals, storing data, displaying data, viewing media content, extracting content data objects, generating relevance data objects, viewing relevance data objects, and/or generating, sending, and/or receiving segment selection indications. For example, the user device may be capable of, but not limited to, one or more of displaying media content, transmitting user input that triggers a dynamic content extraction process (e.g., segment selection indication), receiving user input that triggers a dynamic content extraction process, performing a dynamic content extraction process, or delivering relevance data objects to a user. The user device may (e.g., a smartphone) or may not (e.g., a standalone, IR-based remote control) have a display. A user device may be handheld or movably or immovably stationary. Non limiting examples of a user device include a television, a set top box (which may or may not be used with other user devices, such as a television), a streaming device (e.g., a Roku™ stick) a router, a modem, a laptop, a smartphone, a desktop, a tablet, a smart watch, a universal serial bus (USB) stick, a remote control (e.g., IR-based remote control, RF-based remote control, and/or the like), a keyboard, a mouse, voice control, stylus, touch screen, and/or the like.

As used herein, the term “display” (noun) refers to a visual output component of certain user devices that may be used to visually display content including, but not limited to visual media content, a captured image or other portion of visual media content, and/or an application (e.g., visual media content application or related application, including web pages and the like). In some embodiments, “displaying” or “display” (verb, gerund, etc.) may refer to the action performed by such displays.

As used herein, the term “visual media content” refers to any visual content provided to a user or configured to be provided to a user electronically via a display. Visual media content may be delivered to the display via any of a variety of communication channels including, but not limited to, wired or wireless communication using the internet, locally stored media, a set-top-box, over-the-air broadcast, local area wired or wireless network, cellular network, or any other wired or wireless transmission means and/or storage means capable of facilitating the display of visual media content on a user device. Visual media content may be broken into one or more segments, such as temporal segments such as frames, clips, or other portions defined in visual presentation by time or substitutes for time (e.g., frame number) and/or spatial segments such as portions of a larger frame or other segment, which themselves may be divided into segments. Examples of visual media content include, but are not limited to, movies, television shows, streams (e.g., content delivered via Twitch™ or YouTube™ media platforms), short video clips (e.g., content delivered via Reels™ or TikTok™ media platforms), live event feeds, or other video content whether locally stored and played or remotely streamed and whether delivered over-the-air, via cable provider through a set top box, via internet stream, or through any other means. The visual media content may include one or more frames configured to be delivered sequentially to a user in a continuous manner and at a suitable rate (e.g., a standard video framerate, such as 20 to 240 Hz). The visual media content may be renderable on a display of a user device. In some examples, actions associated with rendering/displaying of visual media content on a display including, but not limited to, one or more of pausing the visual media content, causing the visual media content or a portion thereof to be displayed on a second display, or causing the visual media content to be displayed simultaneously on multiple displays, may be controllable by certain user devices. In some examples, the visual media content may include one or more scenes with each scene including one or more frames.

As used herein, the term “frame” refers to an individual image that makes up visual media content. A frame may be configured to be rendered on a display of a user device. A frame may be decomposable into one or more spatial segments, which spatial segments may overlap or be mutually exclusive. A frame may be associated with a frame identifier. A frame may include visual representations of one or more content objects. A frame may include other images, screenshots, and the like from visual media content and does not require an official designation by the visual media content creator or pre-assignment of a formal frame identifier. For example, a screenshot taken from a video, either via external camera or via internal screen capture software, may be considered a “frame”.

As used herein, the term “frame identifier” refers to one or more datum by which a frame may be identified. A frame identifier may be configured to uniquely identify a frame or frames at one or more different levels of granularity. For example, a frame identifier may be configured to uniquely identify a particular frame from other frames in a particular scene and/or may be configured to uniquely identify the particular frame from other frames in the visual media content as a whole. In some examples, the frame identifier may comprise ASCII text, a pointer, a memory address, and/or other data. In some examples, the frame identifier may include data that describes temporal features of the frame. For example, the frame identifier may include a frame number or timestamp that identifies the position of a frame relative to other frames of the visual media content. The frame identifier may be embedded within the frame, assigned by a user device other than the visual media content creator/distributor, or otherwise allocated to the visual media content. Alternatively or additionally, the frame identifier may be stored in a memory.

As used herein the term “temporal indicator” may refer to one or more datum by which a temporal subset of visual media content may be identified. For example, a temporal indicator may be associated with a segment selection indication and may be leveraged to identify a temporal subset of visual media content corresponding to the segment selection indication. A temporal indicator may be associated with a segment selection indication in a manner that the temporal indicator may be identified, decoded, or otherwise extracted from the segment selection indication. For example, a temporal indicator may be generated as part of the segment selection indication (e.g., a frame or frames currently displayed at the time the user input is received, a timestamp associated with the user input which may then be correlated with a timestamp of the visual media content, or the like). In some embodiments, the temporal indicator may be derived from the segment selection indication, such as a time that the segment selection indication and/or user interaction associated with the segment selection indication is received by a receiving apparatus and/or a frame of the visual media content correlated to said time. Non-limiting examples of a temporal indicator include one or more scene identifiers, frame identifiers, timestamps, and/or the like.

As used herein, the term “spatial segment indicator” refers to one or more datum by which spatial subset of visual media content may be identified. For example, a spatial segment indicator may identify a subset of a frame. A spatial segment indicator may indicate a pixel or pixels (or other spatial segments) identified by a user based on a signal received from a user device, a boundary of an object based on a pixel identified by the user, and/or the like. For example, a spatial segment indicator may be associated with a segment selection indication and may be leveraged to identify a subset of visual media content (e.g., a subset of a frame) corresponding to the segment selection indication. A spatial segment indicator may be associated with a segment selection indication in a manner that the spatial segment indicator may be identified, decoded, or otherwise extracted from the segment selection indication. For example, a spatial segment indicator may be generated as part of the segment selection indication. A spatial segment indicator may correspond to a single point in the frame or a region in the frame. The shape of the spatial segment identified by the spatial segment indicator may be a regular geometric shape (e.g., a square or rectangle, such as a quadrant of a frame shown on a display) or an irregular shape (e.g., an outline of a content object visually rendered in the frame). Non-limiting examples of a spatial segment indicator includes location coordinates (e.g., X-Y coordinates on a display or frame), location identifiers, or other data configured to identify a particular location in the frame or frames currently displayed at the time the user interaction (e.g., user input) that caused generation of the segment selection indication is received.

As used herein, the term “content object” refers to an article, object, entity, feature, and/or any other item, visual representations of which may be rendered on a display, for example, as part of visual media content. A content object may include animate and/or inanimate objects. For example, a content object may include clothing, a shoe, a shirt, a car, a cat, a person, a plant, a lamp, a billboard, a road sign, and/or the like. In some embodiments, content data (e.g., data relating to a content object) may be stored in one or more content data repositories, and such data may include, but is not limited to color, style, type, manufacturer, model, SKU/serial number, year of production, visual representation (e.g., image of the content object), etc. A visual representation of a content object may be rendered within a particular location in a frame of visual media content. A visual representation of a content object may or may not be pre-assigned a content object identifier.

As used herein, the term “content data object” refers to one or more datum extracted directly or indirectly from visual media content (e.g., extracted by excision, isolation, calculation, retrieval, or the like). A content data object may be used with a machine learning relevance model or other techniques to generate a relevance data object. In some embodiments, a content data object includes data that may be leveraged to identify a content object or information associated with a content object visually rendered in the visual media content either directly (e.g., via an image or description of a content object or one or more attributes thereof) or indirectly (e.g., via an image or descriptor of an identified region of a frame). In some embodiments, a content data object may include data associated with a content object, including a content object identifier (e.g., descriptor of a content object, attributes, etc.) and/or other data, including images and non-image data, associated with one or more content objects. The content data object may be capable of being transmitted, received, and/or stored. By way of example, the content data object may include one or more content object identifiers, one or more spatial segments (e.g., one or more images of a content object visually rendered in visual media content), temporal segments (e.g., frame(s), scene(s), etc.), and/or the like. For example, a content data object may include a spatial segment of a frame of the visual media content, which may be visually analyzed (e.g., via image recognition algorithm) to generate a relevance data object (e.g., either via direct image analysis or via generating textual or other data outputs based on the visual analysis which may then be fed into a relevance apparatus). In another example, the content data object may include a text-based description (e.g., a content object identifier) or other non-image data associated with the content object which may be processed (e.g., via natural language processing or other algorithms and/or applications) to generate a relevance data object. The content data object may include an output of an image analysis of the spatial segment to generate the text-based description or other non-image data in some such embodiments. In some embodiments, a content data object may be identified and/or defined visually in one or more frames of visual media content either directly (e.g., via programmatic visual analysis of the video media content) or indirectly (e.g., via identification of one or more content objects associated with a frame or a spatial segment of a frame). In some embodiments, a content data object may be identified via display of a list to a user via a user device and subsequently receiving a selection of an icon representing a content object, which content object may then form the basis for the content data object via incorporation of the content object identifier, as defined below.

As used herein, the term “content object identifier” refers to one or more datum by which a content object or a group of content objects may be identified or otherwise characterized. A content object identifier may be configured to uniquely identify a content object or group of content objects at one or more different levels of granularity. For example, the content object identifier may be configured to uniquely identify a particular visual representation of a content object from visual representations of other content objects in a particular frame. As another example, the content identifier may be configured to uniquely identify a particular visual representation of the content object from visual representations of other content objects in a particular scene. As yet another example, a content identifier may be configured to uniquely identify a particular visual representation of a content object from visual representations of other content objects in the visual media content as a whole. In some embodiments, a content object identifier may identify one or more attributes (e.g., color, style, type, manufacturer, model, SKU/serial number, year of production, visual representation (e.g., image of the content object), etc.) associated with the content object or group of content objects. In some examples, a content object identifier may comprise ASCII text, a pointer, a memory address, and/or other data.

As used herein, the term “relevance data object” refers to an output of a dynamic content extraction process, including a relevance process. A relevance data object may include contextually relevant data (e.g., content object identifier, including one or more recommended content objects or attributes associated therewith, and/or the like) for one or more content objects visually rendered in visual media content or content objects or other information otherwise determined via the dynamic content extraction process to be relevant to the content objects visually rendered in the visual media content (e.g., within a threshold score of the visually rendered content objects). In some embodiments, the relevance data object may include data for one or more similar objects with respect to a content object that is visually rendered in visual media content and identified as a content object of interest as calculated in accordance with the various embodiments herein (e.g., using a relevance score). For example, a relevance data object may be generated in response to a segment selection indication indicating an interest in one or more content objects visually rendered in visual media content. In some examples, a relevance data object may be generated based on user data and/or contextual data associated with the user in combination with the content data object or otherwise with a segment selection indication, segment of visual media content, or the like.

As used herein, the term “segment selection indication” refers to any signals, data, instructions, messages, and/or or the like configured to trigger or otherwise initiate a dynamic content extraction process and/or otherwise configured to generate a relevance data object corresponding to the segment selection indication. The segment selection indication may comprise a user input indicating an interest in one or more content objects visually rendered in visual media content. In some examples, the segment selection indication may be generated in response to user input via one or more user devices. For example, a segment selection indication may include a signal generated in response to a user selecting a portion of visual media content via touch screen input on a display while the visual media content is displayed. In some embodiments, a segment selection indication may include image data, such as a screenshot or photograph of a segment of visual media content. In some embodiments, the segment selection indication may comprise data configured to enable a receiving device (e.g., an extraction apparatus) to generate image data or other non-image data related to the segment of visual media content (e.g., the extraction apparatus itself may generate the image data or other non-image data, or a portion thereof, in response to the segment selection indication). The segment selection indication may include a temporal indicator identifying the time or an equivalent thereof (e.g., a frame or frames) during which the user's input was received on the interface, such that the segment of the visual media content (e.g., spatial and/or temporal segment) may be identified and analyzed via extraction of the content data object to generate the relevance data object. In some embodiments, the temporal indicator may be implicitly associated with the segment selection indication (e.g., a timestamp that the segment selection indication is received by a receiving device, such as an extraction apparatus, may define the temporal indicator). In some embodiments, a segment selection indication may include a signal generated in response to a user pressing a button on a remote-control embodiment of a user device (e.g., a remote control) and localization of a portion of a television screen to which the user indicated (e.g., a pixel coordinate location spatial segment). In this regard, the segment selection indication may indicate the user's interest in one or more content objects visually rendered in visual media content being viewed by the user. In some examples, the segments selection indication may be proactively generated without an affirmative action by a user. In this regard, the segment selection indication may indicate an inferred user interest in one or more content objects.

As used herein, the term “scene identifier” refers to one or more datum by which a scene may be identified. A scene may include a subset or other identifiable portion of visual media content (e.g., a plurality of frames). A scene identifier may be configured to uniquely identify a scene in visual media content from other scenes in the visual media content. In some examples, the scene identifier may comprise ASCII text, a pointer, a memory address, and/or other data. In some examples, the scene identifier may include data that describes temporal features of the scene. For example, the scene identifier may include a scene number that identifies the position of a scene relative to other scenes of the visual media content.

As used herein, the term “machine learning relevance model” may refer to a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. The machine learning relevance model may be configured, trained, and/or the like to generate a relevance data object based on a content data object and/or other relevant data (e.g., content data, user data, and/or contextual data). The machine learning relevance model may include one or more of any type of machine learning models including one or more supervised, unsupervised, semi-supervised, reinforcement learning models, and/or the like. In some examples, the machine learning relevance model may include multiple models configured to perform one or more different stages of a relevance prediction process.

### System Architecture

Embodiments of the present disclosure may be implemented in various ways, including as computer program products that comprise articles of manufacture, as hardware, including circuitry, configured to perform one or more functions, and/or as combinations of specific hardware and computer program products. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as one or more methods, apparatuses, systems, computing devices (e.g., user devices, servers, etc.), computing entities, and/or the like. As such, embodiments of the present disclosure may take the form of an apparatus, system, computing device, computing entity, and/or the like executing instructions stored on one or more computer-readable storage mediums (e.g., via the aforementioned software components and computer program products) to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams, flowchart illustrations, and other example visualizations. It should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. In embodiments in which specific hardware is described, it is understood that such specific hardware is one example embodiment and may work in conjunction with one or more apparatuses or as a single apparatus or combination of a smaller number of apparatuses consistent with the foregoing according to the various examples described herein. Accordingly, the block diagrams and flowchart illustrations support various combinations of embodiments for performing the specified instructions, operations, or steps.

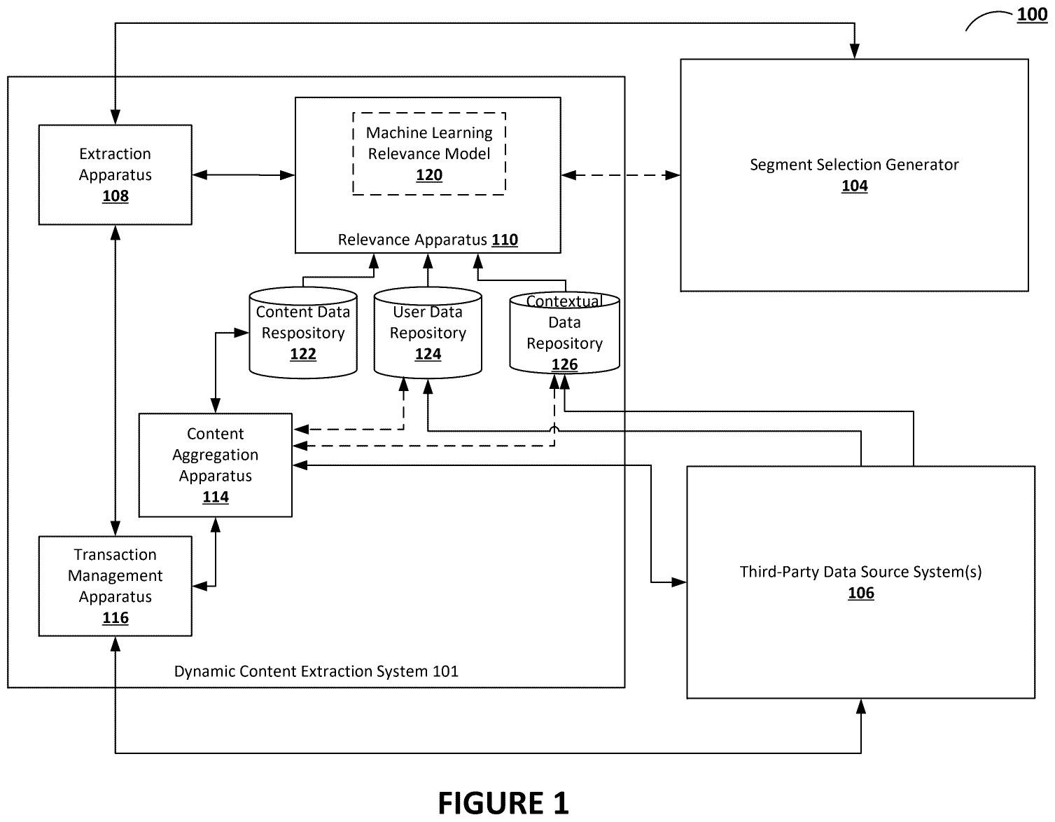

In this regard, FIG. 1 shows an example system environment 100 within which at least some embodiments of the present disclosure may operate. The depiction of the example system environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the system environment 100 disclosed therein is merely presented to provide an example basis and context for the facilitation of some of the features, aspects, and uses of the methods, apparatuses, computer readable media, and computer program products disclosed and contemplated herein.

It will be understood that while many of the aspects and components presented in FIG. 1 are shown as discrete, separate elements, other configurations may be used in connection with the methods, apparatuses, computer readable media, and computer programs described herein, including configurations that combine, omit, separate, and/or add aspects and/or components. For example, in some embodiments, the functions of one or more of the illustrated components in FIG. 1 may be performed by a single computing device or by multiple computing devices, which devices may be local or cloud based. It will be appreciated that the various functions performed by two or more of the dynamic content extraction system 101, the segment selection generator 104, and/or the one or more third-party data source systems 106 may be embodied by a single apparatus, subsystem, or system comprising one or more sets of computing hardware (e.g., processor(s) and memory) configured to perform various functions thereof.

As shown in FIG. 1, the example system environment 100 includes a dynamic content extraction system 101 in communication with a segment selection generator 104 and/or one or more third-party data source systems 106. The dynamic content extraction system 101 may include an extraction apparatus 108, relevance apparatus 110, content aggregation apparatus 114, and/or transaction management apparatus 116. One or more of the extraction apparatus 108, relevance apparatus 110, content aggregation apparatus 114, and transaction management apparatus 116 may be communicatively coupled to a content data repository 122, user data repository 124, and/or contextual data repository 126.

In some embodiments, the functions of one or more of the illustrated components of the dynamic content extraction system 101 may be performed by a single computing device or by multiple computing devices, which devices may be local or cloud based. It will be appreciated that the various functions performed by two or more of the extraction apparatus 108, relevance apparatus 110, content aggregation apparatus 114, and/or transaction management apparatus 116 may be performed by a single apparatus, subsystem, or system. For example, two or more of the extraction apparatus 108, relevance apparatus 110, content aggregation apparatus 114, and/or transaction management apparatus 116 may be embodied by a single apparatus, subsystem, or system comprising one or more sets of computing hardware (e.g., processor(s) and memory) configured to perform various functions thereof.

The various functions of the dynamic content extraction system 101 and system environment 100 may be performed by other arrangements of one or more computing devices and/or computing systems without departing from the scope of the present disclosure. In some embodiments, a computing system may comprise one or more computing devices (e.g., server(s)).

Further, though the content data repository 122, user data repository 124, and contextual data repository 126, identified above, are illustrated as being separate or distinct, two or more of the repositories may be combined into a single repository.

The various components illustrated in the dynamic content extraction system 101 and system environment 100 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols.

In various embodiments, the components depicted in FIG. 1 as being included in the dynamic content extraction system 101, although not required to be an integral system, may be connected via one or more networks. In some embodiments, one or more APIs may be leveraged to communicate with and/or facilitate communication between one or more of the components illustrated in the dynamic content extraction system 101 and system environment 100.

### Example System Operation

The dynamic content extraction system 101 is configured to interact with one or more user devices visually (e.g., via camera capture) and/or electronically. The user device(s) may present the visual media content to a user, and the system may perform content extraction on the visual media content via one or more of the processes described herein. In the embodiment depicted in FIG. 1, the segment selection generator 104 may include one or more user devices, which user devices may include the particular user device(s) presenting the visual media content or may interact with such user devices presenting the visual media content.

The segment selection generator 104 may be configured generate a segment selection indication associated with visual media content and provide the segment selection indication to the dynamic content extraction system 101 (e.g., via the extraction apparatus 108 as further described below). The dynamic content extraction system 101 may thereby perform one or more processes (e.g., extraction and relevance processes) based on the selection indication as described in various embodiments herein.

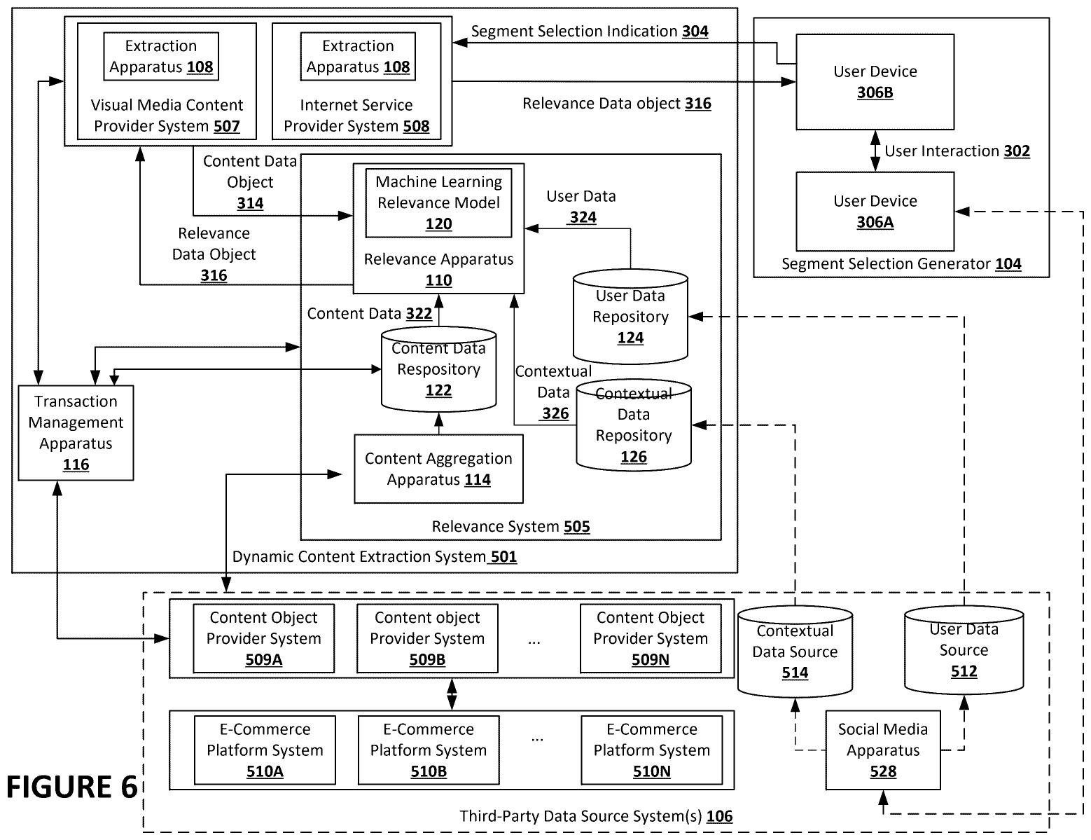

The segment selection indication may be configured to trigger or otherwise initiate a dynamic content extraction process configured to generate a relevance data object. For example, as described below with reference to FIG. 6, in some embodiments, the segment selection generator 104 may be embodied as or otherwise include one or more user devices leveraged to generate the segment selection indication. In one example embodiment, the segment selection indication may be generated by a first user device (e.g., a set-top box or television) receiving a signal from a second user device (e.g., an IR remote) indicating a location on a display of interest to the user. The first user device may thereby generate or coordinate with or more connected devices to generate the segment selection indication based on the location on the display and/or the time (e.g., frame) associated with the signal from the second user device. In another example embodiment, the segment selection indication may be generated by a first user device (e.g., a remote control, smartphone, or the like) in response to a user interaction with the first user device and data captured from a second user device (e.g., set-top box or television). In yet another example embodiment, the functions of the first user device and second user device in the aforementioned example may be performed by a single device (e.g., a smartphone showing the visual media content and receiving a user interaction).

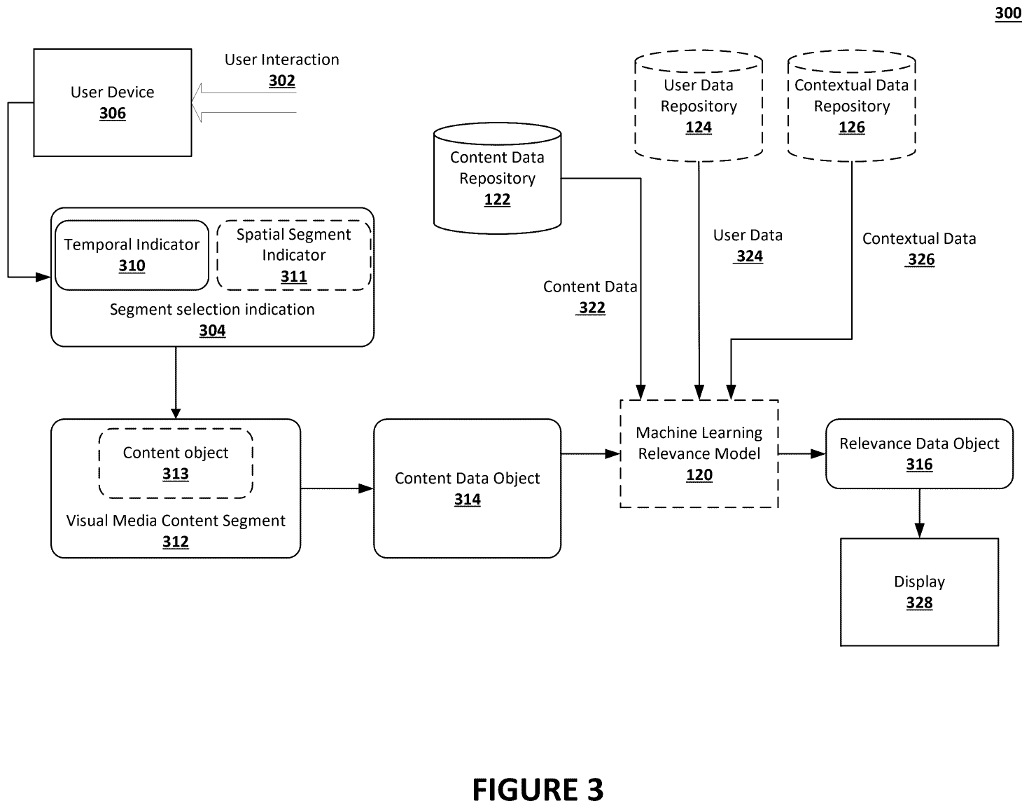

In various embodiments, as shown and further described below with reference to FIG. 3, the segment selection indication includes a temporal indicator and/or a spatial segment indicator that may be leveraged by the dynamic content extraction system 101 (e.g., via the extraction apparatus 108) to extract a content data object corresponding to the segment selection indication.

The extraction apparatus 108 may comprise one or more computing devices embodied in hardware, software, firmware and/or a combination thereof configured to facilitate and/or perform one or more functions associated with dynamic content extraction in visual media content. In various embodiments, the extraction apparatus 108 is configured to receive a segment selection indication associated with visual media content from the segment selection generator 104, identify a segment of the visual media content based on temporal indicator and/or spatial segment indicator associated with the segment selection indication, and extract a content data object from at least one portion of the segment of the visual media content. For example, a visual representation of a content object may be rendered within a particular location in a frame of visual media content (e.g., a segment of the visual media content), whereby a function of the extraction apparatus 108 includes extracting a content data object from at least one portion of the segment of the visual media content.

In some embodiments, the content data object may include data that may be leveraged by the relevance apparatus 110 to identify a content object or information associated with a content object visually rendered in the visual media content either directly or indirectly. In some embodiments, the content data object includes one or more spatial segments of one or more frames (e.g., one or more images of a content object visually rendered in visual media content), one or more content object identifiers, and/or the like which may be analyzed by the relevance apparatus 110 to generate a relevance data object.

The extraction apparatus 108 may extract a content data object from a segment of visual media content. For example, the extraction apparatus 108 may utilize one or more image recognition algorithms, lookup tables, string-searching algorithms, natural language processing techniques, and/or the like to extract a content data object from a segment of visual media content in response to receiving a segment selection indication from the segment selection generator 104. For example, in some embodiments, the extraction apparatus 108 may extract a content data object that identifies, directly or indirectly, a content object rendered in the visual media content and/or attributes associated therewith corresponding to the segment selection indication (e.g., in response to user input) by performing image analysis (e.g., via application of one or more image recognition algorithms) on the segment of the visual media content identified based on temporal indicator and/or spatial segment. In some embodiments, the content data object output from the extraction apparatus 108 may be in the form of image data or other data (e.g., text data), which may be fed into the relevance apparatus 110. In some embodiments, the content data object may be structured data fed into the relevance apparatus 110.

The relevance apparatus 110 may comprise one or more computing devices embodied in hardware, software, firmware and/or a combination thereof configured to facilitate and/or perform one or more functions associated with dynamic content extraction in visual media content. In various embodiments, the relevance apparatus 110 is configured to receive a content data object from the extraction apparatus 108, and analyze, process, and/or the like, the content data object to generate a relevance data object for the user associated with the segment selection indication. In this regard, the relevance apparatus 110 may include hardware, software, firmware and/or a combination thereof configured to receive instructions, signals, data, and/or the like originating from one or more components of the dynamic content extraction system 101 or the system environment 100 to facilitate at least one stage of a dynamic content extraction process via generating a relevance data object, as described herein.

The relevance apparatus 110 may generate a relevance data object in response to receiving a content data object from the extraction apparatus 108. For example, in some embodiments in which the content data object includes a text-based description (e.g., text string) such as a content object identifier embodied as text, or other non-image data, the relevance apparatus 110 may, via lookup tables, string-searching algorithms, natural language processing, etc., process the text-based description to generate a relevance data object. In some embodiments, this may include applying text matching or other text string processing techniques based on the text-based description and content data repository 122 to identify relevant content data (e.g., color, style, type, manufacturer, model, SKU/serial number, year of production, visual representation (e.g., image of the content object), etc.) in the content data repository 122 that correspond to the visually rendered content object associated with the segment selection indication. The relevance data object may then include representations associated with one or more content objects and/or other information associated therewith. In some embodiments, an example text string processing technique may include programmatically generating matching scores, relevance scores, and/or the like using a machine learning model that receives the content data object and content data stored in the content data repository 122. The process may further include determining whether the score satisfies a threshold, has a highest rank, or the like (e.g., meeting predetermined criteria to be presented to a user). In such embodiments, content data that satisfy the predetermined criteria may be determined to constitute relevant data with respect to the segment selection indication.

In some embodiments, where the content data object includes image data, such as in the form of a spatial segment (e.g., spatial segment of a frame of the visual content data), an entire frame or frames, or a scene of the visual media content, the relevance apparatus 110 may visually analyze, via one or more image recognition algorithms, the image data (e.g., spatial segment) to generate a relevance data object. In some embodiments, this includes matching the image data (e.g., spatial segment) to a stored or otherwise previously captured image of a content object (e.g., which may be accessed from the content data repository 122 or other data source) using one or more image recognition algorithms (e.g., machine learning algorithms including but not limited to Convolutional Neural Networks (CNN), Residual Neural Networks (ResNet), Recurrent Neural Networks, Support Vector Machines, or the like). In some embodiments, matching the image data representing a content object captured in the visual media content relative to an image of a content object or objects retrieved from the content data repository 122 (or other data source) includes programmatically generating a matching score, relevance score, and/or the like for the retrieved image of the stored image of the content object with respect to the image data, and determining whether the relevance score satisfies a threshold. For example, feature extraction may be performed on the image data, and similarity measurements may be calculated based on the extracted features.

In some embodiments, the relevance data object may then be generated based on the aforementioned image analysis to present a recommended content object or objects to the user. For example, the recommended content object may be determined based on the matching content object identified based on the image data (e.g., the spatial segment) or based on a similar content object, data associated with each of which may be retrieved from the content data repository 122. For example, the output of the relevance apparatus 110 may include a textual output (e.g., a text-based description of the matching content object, a hyperlink to a store associated with the content object, or the like) and/or an image output (e.g., a picture of the recommended content object).

In some embodiments, the machine learning model(s) may execute in one or more layers or steps, whether executed sequentially in various orders or concurrently. In some embodiments, one or more layers may be omitted or included selectively. By way of an example, a first layer of the machine learning model(s) may comprise characterizing the content object in the segment of visual media content or any other aspect of the segment of the visual media content. The first layer output may be in the form of image data and/or non-image data. A second layer of the machine learning model(s) may comprise calculating a score or other matching or ranking algorithm between the output of the first layer and one or more stored content object data sets in a content object repository. The output of the second layer may comprise one or more results and the one or more results may include direct matches of the content and/or non-direct matches. A third layer of the machine learning model(s) may include weighting the score or other matching process based on user data and/or context data or otherwise incorporating the user data and/or context data into the output of the second layer. In some embodiments, an output of the second or third layer may be incorporated into a relevance data object.

In some embodiments, the content data repository 122 may be associated with a lookup table that is leveraged by the relevance apparatus 110 to identify, based on the content data object, matching or otherwise relevant content data in the content data repository 122. In some embodiments, the content data repository 122 may include structured data aggregated for a plurality of content objects based on one or more attributes of the content objects (e.g., color, style, type, manufacturer, model, SKU/serial number, year of production, visual representation (e.g., image of the content object), etc.). In some embodiments, the content data repository 122 may be updated (e.g., periodically) with new content objects for use by the relevance apparatus 110. In some embodiments, the relevance apparatus 110 may train a plurality of machine learning models based on one or more subsets of the content object attributes, including but not limited to direct matching models (e.g., identifying an exact match for the content object captured in the segment of visual media content) and/or similarity matching models (e.g., matching one or more recommended content objects with the content object captured in the segment of visual media content based on one or more predetermined criteria).

Additionally, in some embodiments, the relevance apparatus 110 may be configured to generate a relevance data object based on other data either alone or in combination with data from the content data repository 122. For example, the relevance apparatus 110 may be configured to generate a relevance data object based on content data accessed from the content data repository 122, user data accessed from the user data repository 124, and/or contextual data accessed from the contextual data repository 126 in combination with the content data object. In some embodiments, the relevance apparatus 110 may be configured to generate the relevance data object without a content data object based solely on one or more algorithms (e.g., machine learning algorithms) run on data from the content data repository 122, user data accessed from the user data repository 124, and/or contextual data accessed from the contextual data repository 126 with or without additional data from a user, such as a segment selection indication, segment of visual media content, or the like. The relevance apparatus 110 may retrieve or otherwise access the user data and/or contextual data from one or more repositories, such as the user data repository 124 as shown in FIG. 1 and/or the contextual data repository 126 as shown in FIG. 1.

In some embodiments, content data embodied as a content data object and/or relevance data object may include attributes of one or more content objects visually rendered in visual media content or attributes of one or more content objects similar to content objects visually rendered in visual media content. Non-limited examples of content data include, but are not limited to any indicator or representation of a content object or any one or more attributes associated with a content object including, but not limited to, color, style, type, manufacturer, model, SKU/serial number, year of production, visual representation (e.g., image of the content object), etc.

In some embodiments, the user data includes information associated with the user from which the segment selection indication originates or one or more additional users (e.g., aggregated user data). The user data may include, but is not limited to, historical user data, user transaction data, user demographic data, user behavior data, and/or social media data (e.g., posts and feed information) of the user(s). The user data may be leveraged to generate a relevance data object containing relevant content data for a user based on the segment selection indication with or without the content data object. For example, in some embodiments, user data may be used to define the predetermined criteria for generating the relevance data object based on the content data object. In some embodiments, the user data may be used to weight the scores associated with generating the relevance data object based on the content data object. In some embodiments, the user data may be used to filter a subset of the available stored content objects prior to generating the relevance data object. In some embodiments, the user data may be used independently of a content data object to generate a relevance data object based solely on user data or based on a combination of user data and other data (e.g., recommending a content object to a user based on the user's past interests and current trends in a contextual data repository 126).

In some embodiments, the contextual data includes data not related to a specific, identified user including, but not limited to, social media trends, industry trends, and/or other relevant data that may be leveraged to generate a relevance data object containing contextually relevant data for a user based on the segment selection indication with or without the content data object. For example, in some embodiments, context data may be used to define the predetermined criteria for generating the relevance data object based on the content data object. In some embodiments, the context data may be used to weight the scores associated with generating the relevance data object based on the content data object. In some embodiments, the context data may be used to filter a subset of the available stored content objects prior to generating the relevance data object. In some embodiments, the context data may be used independently of a content data object to generate a relevance data object based solely on context data (e.g., recommend a top trending content object to a customer) or based on a combination of context data and other data (e.g., recommending a content object to a user based on the user's past interests and current trends).

In some embodiments, the relevance apparatus 110 leverages one or more machine learning relevance models 120 to generate the relevance data object based on the content data object, corresponding content data, user data, and/or contextual data associated with the user (or group of users). For example, the content data object, output of an image analysis based on the content data object (as described above), content data from a content data repository 122, user data from a user data repository 124, and/or contextual data from a contextual data repository 126, may be input to the machine learning relevance model(s) 120 to analyze the input to the machine learning model and output a relevance data object based on the analysis. In some embodiments, the machine learning model(s) 120 may be configured to adapt relevance data objects based at least in part on contextual data (e.g., consumer behavior, industry trends, social media engines feeds, and/or other information streams) and/or user data.

In various embodiments, the relevance apparatus 110 may include hardware components, software components, and/or a combination thereof configured to request, receive, process, generate, and transmit data, data structures, control signals, and electronic information for training and executing the machine learning relevance model(s) 120. The machine learning relevance model(s) 120 may be trained using historical, structured data having the attributes of the various data discussed herein. In various embodiments, the relevance apparatus 110 including, in some example embodiments, the machine learning relevance model(s) 120 may be configured to compile insight information into the relevance data object from multitude inputs (e.g., content data object content data repository, user data repository, contextual data repository, etc.). In some embodiments, such inputs into the machine learning relevance model(s) may include, but are not limited to: retailer offering the best price, available promotions, insights relevant to the consumer, such as which of their favorite celebrities use the product or social media friends have looked at this product, closet retail location or order it from or even providing one click offer to buy it from major e-commerce channels. Contextually relevant insights may point to other content objects that may be complimentary to the content object(s) identified from the visual media content and/or complementary to other content object(s) recently purchased by the consumer.

In some embodiments, the relevance apparatus 110 may include hardware, software, firmware and/or a combination thereof configured to initiate, direct, cause, and/or the like one or more components of the system environment 100 to perform one or more functions associated with dynamic content extraction in visual media content. For example, in some embodiments, the relevance apparatus 110 is configured to cause transmission of the relevance data object to a user device, display of the relevance data object on a user device, or other directly or indirectly trigger display of the relevance data object, including one or more content data items therein, to the user.

The content aggregation apparatus 114 may comprise one or more computing devices embodied in hardware, software, firmware and/or a combination thereof configured to facilitate and/or perform one or more functions associated with dynamic content extraction in visual media content. The content aggregation apparatus 114 may facilitate active or passive (e.g., serving as a passthrough, such as via an API for one or more other computing apparatuses and systems) aggregation of data into one or more of the repositories. In various embodiments, the content aggregation apparatus 114 is configured facilitate access to, maintenance and upkeep of, and/or other monitoring and/or modification of one or more repositories including the content data repository 122, user data repository 124, and/or the contextual data repository 126. For example, in some embodiments, the content aggregation apparatus 114 may comprise or otherwise configured to facilitate use of an API configured to allow access to the content data repository 122, user data repository 124, and/or the contextual data repository 126.

In some embodiments, the content aggregation apparatus 114 comprises one or more computing devices embodied in hardware, software, firmware and/or a combination thereof configured to gather, aggregate, prune, process, analyze, and/or otherwise manage data stored in the content data repository 122, user data repository 124, and/or the contextual data repository 126. For example, the content aggregation apparatus 114 may allow one or more third-party data source systems 106 to access the content data repository 122, user data repository 124, and/or the contextual data repository 126 to keep the content data repository 122, user data repository 124, and/or the contextual data repository 126 updated (e.g., with the latest data that may be leveraged by the relevance apparatus 110 to generate a relevance data object).

The transaction management apparatus 116 may comprise one or more computing devices embodied in hardware, software, firmware and/or a combination thereof configured to facilitate and/or perform one or more functions associated with dynamic content extraction in visual media content. In some embodiments, the transaction management apparatus 116 is configured to initiate, facilitate, track, manage, and/or the like transaction reconciliation (e.g., periodic financial reconciliation or the like) between and among various entities including, for example, third-party data source system(s) 106. For example, the transaction management apparatus 116 may coordinate higher-level decisions between the various components of the dynamic content extraction system 101 such as identifying and/or coordinating third party data source system 106 data intake and management.

### Example Apparatuses of the Disclosure

Having discussed example systems in accordance with the present disclosure, example apparatuses in accordance with the present disclosure will now be described.

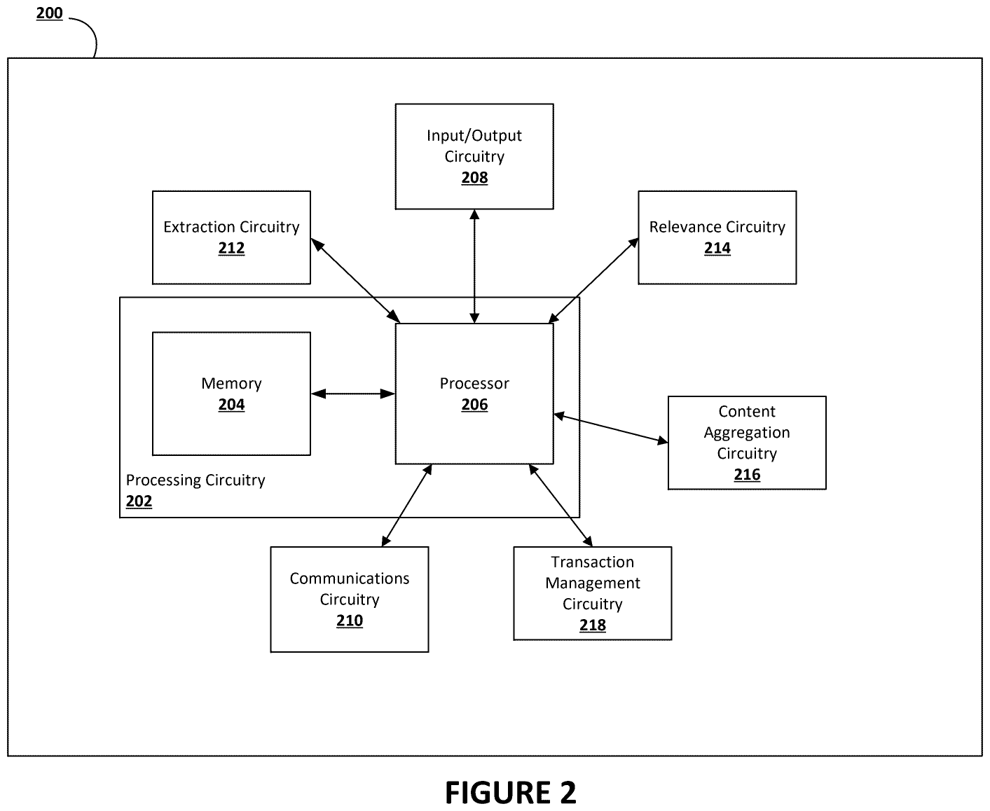

FIG. 2 illustrates a block diagram of an apparatus 200 in accordance with some example embodiments. For example, in some embodiments, the extraction apparatus 108, relevance apparatus 110, content aggregation apparatus 114, and/or dynamic content aggregation apparatus may be embodied by one or more apparatuses 200. In this regard, in some embodiments, the dynamic content extraction system 101 or one or more portions (e.g., one or more individual apparatuses) thereof, if embodied in a particular embodiment, may be embodied by one or more apparatuses 200.

In some embodiments, the apparatus 200 may include a processing circuitry 202 as shown in FIG. 2. It should be noted, however, that the components, or elements illustrated in and described with respect to FIG. 2 below may not be mandatory and thus one or more may be omitted in certain embodiments. Additionally, some embodiments, may include further or different components or elements beyond those illustrated in and described with respect to FIG. 2. In some embodiments, the functionality of the dynamic content extraction system 101, the other devices interacting with the dynamic content extraction system, or any subset thereof may be performed by a single apparatus 200 or multiple apparatuses 200. In some embodiments, the apparatus 200 may comprise one or a plurality of physical devices, including distributed, cloud-based, and/or local devices.

Although some components are described with respect to functional limitations, it should be understood that the particular implementations necessarily include the use of particular computing hardware, such as the hardware shown in FIG. 2. It should also be understood that certain of the components described herein may include similar or common hardware. For example, two sets of circuitries for example, may both leverage use of the same processor(s), network interface(s), storage medium(s), and/or the like, to perform their associated functions, such that duplicate hardware is not required for each set of circuitry and a single physical circuitry may be used to perform the functions of multiple circuitries described herein. The use of the term “circuitry” as used herein with respect to components of the apparatuses described herein should therefore be understood to include particular hardware configured to perform the functions associated with the particular circuitry as described herein.

In some embodiments, “circuitry” may include processing circuitry, storage media, network interfaces, input/output devices, and/or the like. In some embodiments, other elements of the apparatus 200 may provide or supplement the functionality of another particular set of circuitry. For example, the processor 206 in some embodiments provides processing functionality to any of the sets of circuitries, the memory 204 provides storage functionality to any of the sets of circuitry, the communications circuitry 210 provide network interface functionality to any of the sets of circuitry, and/or the like.

The apparatus 200 may include or otherwise be in communication with processing circuitry 202 that is configurable to perform actions in accordance with one or more example embodiments disclosed herein. In this regard, the processing circuitry 202 may be configured to perform and/or control performance of one or more functionalities of the apparatus 200 in accordance with various example embodiments, and thus may provide means for performing functionalities of the apparatus 200 in accordance with various example embodiments. The processing circuitry 202 may be configured to perform data processing, application, and function execution, and/or other processing and management services according to one or more example embodiments. In some embodiments, the apparatus 200 or a portion(s) or component(s) thereof, such as the processing circuitry 202, may be embodied as or comprise a chip or chip set. In other words, apparatus 200 or the processing circuitry 202 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein.

In some embodiments, the processing circuitry 202 may include a processor 206 (and/or co-processor or any other processing circuitry assisting or otherwise associated with the processor) and, in some embodiments, such as that illustrated in FIG. 2, may further include memory 204. The processing circuitry 202 may be in communication with or otherwise control a user interface (e.g., embodied by input/output circuitry 208) and/or a communications circuitry 210. As such, the processing circuitry 202 may be embodied as a circuit chip (e.g., an integrated circuit chip) configured (e.g., with hardware, software or a combination of hardware and software) to perform operations described herein.

The processor 206 may be embodied in a number of different ways. For example, the processor 206 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 206 may comprise a plurality of processors. The plurality of processors may be in operative communication with each other and may be collectively configured to perform one or more functionalities of the apparatus 200 as described herein. In some example embodiments, the processor 206 may be configured to execute instructions stored in the memory 204 or otherwise accessible to the processor 206. As such, whether configured by hardware or by a combination of hardware and software, the processor 206 may represent an entity (e.g., physically embodied in circuitry—in the form of processing circuitry 202) capable of performing operations according to embodiments of the present disclosure while configured accordingly. Thus, for example, when the processor 206 is embodied as an ASIC, FPGA or the like, the processor 206 may be specifically configured hardware for conducting the operations described herein. Alternatively, as another example, when the processor 206 is embodied as an executor of software instructions, the instructions may specifically configure the processor 206 to perform one or more operations described herein. The use of the terms “processor” and “processing circuitry” may be understood to include a single core processor, a multi-core processor, multiple processors internal to the apparatus 200, and/or one or more remote or “cloud” processor(s) external to the apparatus 200.

In some example embodiments, the memory 204 may include one or more non-transitory memory devices such as, for example, volatile and/or non-volatile memory that may be either fixed or removable. In this regard, the memory 204 may comprise a non-transitory computer-readable storage medium. It will be appreciated that while the memory 204 is illustrated as a single memory, the memory 204 may comprise a plurality of memories. The memory 204 may be configured to store information, data, applications, instructions and/or the like for enabling the apparatus 200 to carry out various functions in accordance with one or more example embodiments. For example, the memory 204 may be configured to buffer input data for processing by the processor 206. Additionally or alternatively, the memory 204 may be configured to store instructions for execution by the processor 206. The memory 204 may include one or more databases that may store a variety of files, contents, or data sets. Among the contents of the memory 204, applications may be stored for execution by the processor 206 in order to carry out the functionality associated with each respective application. In some cases, the memory 204 may be in communication with one or more of the processors 206, output circuitry 208 and/or communications circuitry 210, via a bus(es) for passing information among components of the apparatus 200.

The input/output circuitry 208 may provide output to the user or an intermediary device and, in some embodiments, may receive one or more indication(s) of user input. In some embodiments, the input/output circuitry 208 is in communication with processor 206 to provide such functionality. The input/output circuitry 208 may include one or more user interface(s) and/or include a display that may comprise the user interface(s) rendered as a web user interface, an application interface, and/or the like, to the display of a user device, a backend system, or the like. The input/output circuitry 208 may be in communication with the processing circuitry 202 to receive an indication of a user input at the user interface and/or to provide an audible, visual, mechanical, or other output to the user. As such, the input/output circuitry 208 may include, for example, a keyboard, a mouse, a joystick, a display, a touch screen display, a microphone, a speaker, and/or other input/output mechanisms. As such, the input/output circuitry 208 may, in some example embodiments, provide means for a user to access and interact with the apparatus 200. The processor 206 and/or input/output circuitry 208 comprising or otherwise interacting with the processor 206 may be configured to control one or more functions of one or more user interface elements through computer program instructions (e.g., software and/or firmware) stored on a memory accessible to the processor 206 (e.g., stored on memory 204, and/or the like).

The communications circuitry 210 may include one or more interface mechanisms for enabling communication with other devices and/or networks. In some cases, the communications circuitry 210 may be any means such as a device or circuitry embodied in either hardware, or a combination of hardware and software that is configured to receive and/or transmit data from/to a network and/or any other device or module in communication with the processing circuitry 202. The communications circuitry 210 may, for example, include an antenna (or multiple antennas) and supporting hardware and/or software for enabling communications with a wireless communication network (e.g., a wireless local area network, cellular network, global positing system network, and/or the like) and/or a communication modem or other hardware/software for supporting communication via cable, digital subscriber line (DSL), universal serial bus (USB), Ethernet or other methods.

In some embodiments, the apparatus 200 may include an extraction circuitry 212 which may include hardware components, software components, and/or a combination thereof configured to, with the processing circuitry 202, input/output circuitry 208 and/or communications circuitry 210, perform one or more functions associated with the extraction apparatus 108 (as described above with reference to FIG. 1). For example, the extraction circuitry 212 may access, facilitate access, receive process, manipulate, provide, or otherwise use, or make available for use, data (e.g., content data object, transaction data, and/or other data) used by one or more other components of the apparatus 200 through, for example, the use of applications or APIs executed using a processor, such as the processor 206. In some embodiments, the extraction circuitry 212 may interact with the memory 204, which may store the aforementioned data. It should also be appreciated that, in some embodiments, the extraction circuitry 212 may include a separate processor, specially configured field programmable gate array (FPGA), or application specific interface circuit (ASIC) to provide or otherwise facilitate access to such data used by one or more other components of the apparatus 200. The extraction circuitry 212 may also provide for communication with other components of the apparatus, system and/or external systems via a network interface provided by the communications circuitry 210.

In some embodiments, the apparatus 200 may include a relevance circuitry 214 which may include hardware components, software components, and/or a combination thereof configured to, with the processing circuitry 202, input/output circuitry 208 and/or communications circuitry 210, perform one or more functions associated with the relevance apparatus 110 (as described above with reference to FIG. 1). For example, the relevance circuitry 214 may access, facilitate access, receive process, manipulate, provide, or otherwise use, or make available for use, data (e.g., content data object, content data, user data, contextual data, and/or the like) utilized by the relevance apparatus 110 to generate a relevance data object corresponding to a segment selection indication through, for example, the use of applications or APIs executed using a processor, such as the processor 206. In some embodiments, the relevance circuitry 214 may interact with the memory 204, which may store the aforementioned data. It should also be appreciated that, in some embodiments, the relevance circuitry 214 may include a separate processor, specially configured field programmable gate array (FPGA), or application specific interface circuit (ASIC) to receive such data utilized by the relevance circuitry 214. The relevance circuitry 214 may also provide for communication with other components of the apparatus, system and/or external systems via a network interface provided by the communications circuitry 210.

In some embodiments, the apparatus 200 may include a content aggregation circuitry 216 which may include hardware components, software components, and/or a combination thereof configured to, with the processing circuitry 202, input/output circuitry 208 and/or communications circuitry 210, perform one or more functions associated with the content aggregation apparatus 114 (as described above with reference to FIG. 1). For example, the content aggregation circuitry 216 may access, facilitate access, receive process, manipulate, provide, or otherwise use, or make available for use, certain data (e.g., content data, user data, contextual data, social media feeds, and/or the like) used by one or more other components of the apparatus 200 through, for example, the use of applications or APIs executed using a processor, such as the processor 206. In some embodiments, the content aggregation circuitry 216 may interact with the memory 204, which may store the aforementioned data. It should also be appreciated that, in some embodiments, the content aggregation circuitry 216 may include a separate processor, specially configured field programmable gate array (FPGA), or application specific interface circuit (ASIC) to manage access and use of such data. The content aggregation circuitry 216 may also provide for communication with other components of the apparatus, system and/or external systems via a network interface provided by the communications circuitry 210.

In some embodiments, the apparatus 200 may include a transaction management circuitry 218 which may include hardware components, software components, and/or a combination thereof configured to perform one or more functions associated with dynamic content extraction in visual media content such as the example functions discussed above in reference to the transaction management apparatus 116 (as described above with reference to FIG. 1). For example, the transaction management circuitry 218 may access, facilitate access, receive process, manipulate, provide, or otherwise use, or make available for use, data used by one or more other components of the apparatus 200 through, for example, the use of applications or APIs executed using a processor, such as the processor 206. In some embodiments, the transaction management circuitry 218 may interact with the memory 204, which may store the aforementioned data. It should also be appreciated that, in some embodiments, the transaction management circuitry 218 may include a separate processor, specially configured field programmable gate array (FPGA), or application specific interface circuit (ASIC) to manage the access and use of such data. The transaction management circuitry 218 may also provide for communication with other components of the apparatus, system and/or external systems via a network interface provided by the communications circuitry 210.

### Example Processes for Dynamic Content Extraction

FIG. 3 is a data flow diagram 300 showing example data structures for dynamic content extraction in visual media content in accordance with at least some embodiments discussed herein. In some example embodiments, the data structures and processes shown and described with respect to the data flow diagram of FIG. 3 may be generated, performed, and/or otherwise facilitated by the various systems and apparatuses shown and described with respect to FIGS. 1-2.

In some embodiments, a segment selection indication 304 associated with visual media content is received in response to user interaction 302 (e.g., user input). As shown in the illustrated embodiment of FIG. 3, the segment selection indication may be obtained from a user device 306. As described above with reference to FIG. 1, in some embodiments, the segment selection generator 104 may be embodied as or otherwise include one or more user devices configured to generate and transmit a segment selection indication in response to user interaction 302 with the one or more user devices.

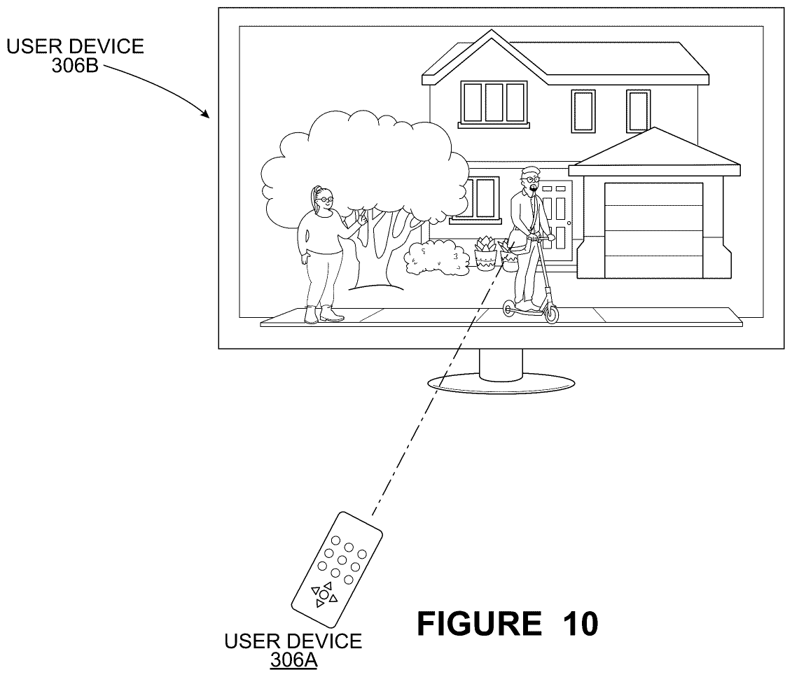

The segment selection indication 304 may be generated in response to user interaction 302. The user may interact with a first user device that triggers at least one second user device (whether locally or remotely connected to the user device(s)) to generate the segment selection indication; the user may interact with a first user device that may, itself, generate the segment selection indication; and/or the first and second user devices may each be separately connected with a third device (e.g., a local user device or a remote apparatus such as the extraction apparatus 108 shown in FIG. 1) configured to interact with each of the first device and the second device (e.g., visual media content may be shown on the second device and a trigger signal comprising the selection indication may be generated by the first device communicating with the third device). By way of example, the user interaction 302 may comprise interaction with the user device 306 via a second user device as further described below in reference to FIG. 6 and as shown in FIG. 10. By way of another example, the user interaction 302 may comprise interaction with the user device 306, directly or indirectly, such as via voice command with or without a second user device. For example, a mobile application, web application, and/or the like rendered on the user device 306 may be configured to allow for a user to input a voice command, corresponding to a segment selection indication, via the application. The application, for example, may be associated with a visual media content provider. By way of yet another example, the user interaction 302 may comprise interaction with the user device 306 via touch with or without a second user device. For example, the user device 306 may include a touchscreen display configured to allow a user to provide an input via the display. The visual media content may be displayed on the same user device that receives the user input (e.g., a smartphone showing visual media content) or the visual media content may be displayed on a second user device (e.g., a smart television).

In this regard, in some embodiments, one or more user devices may be leveraged to generate and transmit a segment selection indication configured to trigger or otherwise initiate, whether directly or indirectly, a dynamic extraction process configured to generate a relevance data object. For example, in some example implementations the segment selection indication 304 may be generated by the same user device 306. As another example, in some example implementations, the segment selection indication 304 may be generated by a second user device in response to user input at a first device as described herein and shown in FIGS. 6 and 10. In some example implementations, the segment selection indication may be generated by a first user device (whether or not such device receives the user input) and transmitted to a dynamic content extraction system (e.g., system 101 shown in FIG. 1) via a second user device. A third user device may be used to facilitate any of the foregoing input and/or segment selection indication generation or transmission processes. In some embodiments, the user interaction 302 configured to generate the segment selection indication 304 may comprise or may be generated in response to a plurality of user inputs (e.g., a first input configured to prompt display of a list of content items for selection and a second input selecting one of the content items from the list).

In some embodiments, as described above with reference to FIG. 1, the extraction apparatus 108 may be configured to receive the segment selection indication 304. The segment selection indication 304 may comprise the signals sent by the user device(s) to the dynamic content extraction system (e.g., system 101 shown in FIG. 1). The segment selection indication may, for example, include, implicitly or explicitly, a temporal indicator 310 and/or a spatial segment indicator 311.

In some embodiments, a visual media content segment 312 (e.g., a segment of the visual media content) is identified based on the segment selection indication 304. In some embodiments, an extraction apparatus (e.g., extraction apparatus 108 shown in FIG. 1) may be configured to identify the visual media content segment in response to receiving the segment selection indication 304. For example, the visual media content segment 312 identifies a portion of visual media content corresponding to the segment selection indication (e.g., the portion of the visual media content that the user selected via user interaction 302 with the user device 306 or otherwise one or more frames of the visual media content displayed on the user device 306).

In some embodiments, the visual media content segment 312 may identify a temporal segment of the visual media content such as a frame, video clip, or the like (e.g., portions defined in visual presentation by time or substitutes for time). Alternatively or additionally, in some embodiments, the visual media content segment 312 may identify a spatial segment such as a visual representation of a content object (e.g., a piece of clothing, a table, or the like) in the visual media content, a region (e.g., quadrant or the like) of the display of the user device 306, region of the current frame rendered on the display of user device 306 at the time the user interaction 302 is received, or the like (e.g., spatial portions of a larger frame or other segment, such as an X-Y coordinate location on the display and/or frame corresponding to the user's selection indication). For example, the visual media content segment 312 may be generated based on a temporal indicator 310 associated with the segment selection indication 304 and/or spatial segment indicator 311 associated with the segment selection indication 304. As shown in FIG. 3, in some embodiments, the segment selection indication 304 includes a temporal indicator 310 and may also include a spatial segment indicator 311.

In some embodiments, a temporal indicator is one or more datum by which a temporal subset of the visual media content may be identified. For example, the temporal indicator 310 may be associated with the segment selection indication 304 and may be leveraged to identify a temporal subset of the visual media content corresponding to the segment selection indication. The temporal indicator 310 may be associated with a segment selection indication 304 in a manner that the temporal indicator may be identified, decoded, or otherwise extracted from the segment selection indication 304. For example, the temporal indicator 310 may be generated as part of the segment selection indication 304 (e.g., a frame or frames currently displayed at the time the user input (e.g., user interaction) is received, a timestamp associated with the user input which may then be correlated with a timestamp of the visual media content, or the like). In some embodiments, the temporal indicator may be derived from the segment selection indication, such as a time that the segment selection indication and/or user interaction associated with the segment selection indication is received by a receiving apparatus and/or a frame of the visual media content correlated to said time. Non-limiting examples of a temporal indicator include one or more scene identifiers, frame identifiers, timestamps, and/or the like.

In some embodiments, a spatial segment indicator is one or more datum by which spatial subset of visual media content may be identified. For example, the spatial segment indicator 311 may identify a subset of a frame. A spatial segment indicator may indicate a pixel or pixels (or another spatial segment) identified by a user based on a signal received from the user device 306, a boundary of an object based on a pixel identified by the user, and/or the like. For example, the spatial segment indicator 311 may be associated with the segment selection indication and may be leveraged to identify a subset of visual media content corresponding to the segment selection indication (e.g., a subset of a frame). A spatial segment indicator 311 may be associated with the segment selection indication 304 in a manner that the spatial segment indicator 311 may be identified, decoded, or otherwise extracted from the segment selection indication 304. For example, the spatial segment indicator 311 may be generated as part of the segment selection indication 304. The spatial segment indicator may correspond to a single point in the frame or a region in the frame. The shape of the spatial segment identified by the spatial segment indicator 311 may be a regular geometric shape (e.g., a square or rectangle, such as a quadrant of a frame shown on a display of the user device 306) or an irregular shape (e.g., an outline of a content object visually rendered in the frame). Non-limiting examples of the spatial segment indicator 311 includes location coordinates (e.g., X-Y coordinates on a display or frame), location identifiers, or other data configured to identify a particular location in a frame or frames currently displayed at the time the user interaction 302 (e.g., user input) that caused generation of the segment selection indication is received.

As shown in FIG. 3, the visual media content segment 312 may comprise a content object 313 corresponding to the segment selection indication 304. The content object 313 may be visually rendered (e.g., image data) and/or represented by other data (e.g., a text string). In some embodiments, the visual media content segment 312 may comprise more than one content object.

In some embodiments, as described above with reference to FIG. 1, the extraction apparatus 108 may be configured to identify the visual media content segment 312. In some example embodiments, the process for identification of the visual media content segment 312 may depend upon the amount of detail and the format of the segment selection indication 304. For example, in some embodiments, a detailed segment selection indication 304 may merely require assigning a flag in memory or otherwise associating the segment selection indication with the visual media content segment or processing the segment selection indication as the visual media content segment (e.g., without distinction between the two) to generate the content data object 314 without further analysis. In some embodiments, the visual media content segment may be derived or generated based on the more limited data in the segment selection indication. For example, a timestamp and/or X-Y coordinate may cause the extraction apparatus 108 to retrieve the visual media content or a dataset of content objects associated with the visual media content and identify the corresponding spatial segment and/or temporal segment from comparing the timestamp and/or X-Y coordinate with the retrieved copy of the visual media content or dataset.

In some embodiments, a content data object 314 from at least one portion of the visual media content segment 312 is extracted based on the visual media content segment 312. The content data object 314 may be extracted in any of the forms discussed herein and may be used as the input to the machine learning relevance model 120 (e.g., as executed by a relevance apparatus 110 such as is shown in FIG. 1). As described above with reference to FIG. 1, in some embodiments, a content data object may include a spatial segment of a frame of the visual content data (e.g., one or more images of a content object visually rendered in the visual media content). For example, extracting the content data object 314 may comprise transmitting an image of at least a portion of the visual media content segment 312 (e.g., an image of the spatial segment) to the relevance apparatus (e.g., relevance apparatus 110 shown in FIG. 1).

Alternatively or additionally, in some embodiments, the content data object 314 may include a text-based description (e.g., a content object identifier and/or the like). For example, extracting the content data object 314 may comprise applying one or more image recognition algorithms to identify a content object identifier associated with the content object 313 within the visual media content segment 312 or other text-based description that describes the content object 313 in a manner that a relevance data object may be generated based at least in part on the text-based description. In some embodiments, the visual media content segment 312 may likewise comprise a text-based description from which the content data object 314 may be transmitted to the machine learning relevance model 120.

In some example embodiments, the process for extraction of the content data object 314 may depend upon the amount of detail and the format of the visual media content segment 312 and/or the input criteria for the machine learning relevance model 120. For example, the machine learning relevance model may receive device attributes as inputs to generate a relevance data object within a predetermined criteria (e.g., threshold) of relevance to the input attributes. In such embodiments, the content data object 314 may be defined as attributes (e.g., attributes extracted from the visual media content segment, such as by image recognition, text string analysis, or other means). In some embodiments, the machine learning relevance model may receive images as inputs to generate a relevance data object. In such embodiments, the content data object 314 may be defined as an image comprising the spatial segment, the content object, or other image data as described herein. In some embodiments, the machine learning relevance model may receive non-image data (e.g., text strings) as inputs to generate a relevance data object. In such embodiments, the content data object 314 may be defined as non-image data characterizing the spatial segment, the content object, or other image data as described herein (e.g., content object identifier(s)).

In some embodiments, at one or more points in the dynamic content extraction process, a user may be prompted to select between multiple content objects. The prompt, for example, may be generated during or prior to generation of the segment selection indication (e.g., at a user device) and/or after or during identification of the visual media content segment 312. For example, if the visual media content segment 312 is determined to include two or more visually rendered content objects, the user may be directed, instructed, or the like to select from the two or more visually rendered content data objects via transmission back to one or more user devices and the rendering of a selection graphical user interface at the user device. For example, in some embodiments, a user interface comprising selectable user interface elements (e.g., check boxes, bubbles, buttons, or the like) each corresponding to a visually rendered content data object is displayed on the user device 306 or other user device associated with the user in response to determining that the visual media content segment 312 embodies or otherwise includes two or more visually rendered content objects. The user interface may be configured to allow the user to select some or all of the visually rendered content objects within the visual media content segment 312.

In some embodiments, if the visual media content segment 312 is determined to include visual representations of two or more visually rendered content objects, a content data object 314 may be generated for each of the visually rendered content objects or a single content data object 314 may be generated for all or a subset of the visually rendered content objects.

In some embodiments, as described above with reference to FIG. 1, the extraction apparatus 108 may be configured to extract the content data object 314.

In some embodiments, a relevance data object 316 is generated based on the content data object 314. In some embodiments, the relevance data object 316 may be generated based on corresponding content data 322 retrieved from the content data repository 122, corresponding user data 324 retrieved from the user data repository 124, and/or corresponding contextual data 326 retrieved from the contextual data repository 126 in combination with the content data object 314. As described above, the content data 322 may include content objects and/or attributes of the content object 313 (e.g., content object identifiers) within the visual media content segment 312 and/or content objects and/or attributes of one or more content objects similar to the content object 313. For example, the relevance apparatus 110 (e.g. via a machine learning relevance model 120) may be configured to match the content data object 314 or the content object 313 associated therewith with the content objects (e.g., whether a direct match or a “similar” match) and/or attributes associated therewith stored in the content data repository 122 to generate a relevance data object based on the stored content object and/or content object attributes. In some embodiments, the user data 324 may include historical user data, user behavior data, and/or social media of the user(s); and the contextual data 326 may include social media trends, industry trends, and/or other relevant data associated with the user.

In some embodiments, the content data object 314, content data 322, user data 324, and/or contextual data 326 are input to a machine learning relevance model 120 configured to analyze the content data object 314, content data 322, user data 324, and/or contextual data 326 to generate the relevance data object 316. In some embodiments, as described above with reference to FIG. 1, the content aggregation apparatus 114 may be configured to facilitate and/or manage gathering, storing, maintaining, and/or updating of the content data repository 122, user data repository 124, and/or the contextual data repository 126.

In some embodiments, the machine learning relevance model 120 is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. In some embodiments, the machine learning model(s) may include, in non-limiting example embodiments, Convolutional Neural Networks (CNN), Residual Neural Networks (ResNet), Recurrent Neural Networks, Support Vector Machines, or the like. The machine learning relevance model 120 may be configured, trained, and/or the like to generate a relevance data object based on a content data object, content data, user data, and/or contextual data. The machine learning relevance model 120 may include one or more of any type of machine learning models including one or more supervised, unsupervised, semi-supervised, reinforcement learning models, and/or the like. In some examples, the machine learning relevance model 120 may include multiple models configured to perform one or more different stages of a prediction process. In some examples, the machine learning relevance model 120 may be previously trained.

In some embodiments, where the content data object 314 includes image data from a spatial segment of a frame of the visual content data, the spatial segment (e.g., an image of a subset of a frame, an outline of the visually rendered content object 313, an image of the visually rendered content object 313, or the like) may first be visually analyzed via one or more image recognition algorithms or other techniques to generate textual or other data outputs based on the visual analysis (e.g., image analysis). The generated textual or other data output may then be input to the machine learning relevance model 120 to generate the relevance data object 316.

In some embodiments, the image data associated with the spatial segment may be input directly into the machine learning relevance model 120 to analyze and/or process the spatial segment with one or more of the content data 322, user data 324, or contextual data 326 to generate the relevance data object 316.

In some embodiments, generating the relevance data object 316 may include identifying the content data 322 from the content data repository 122 that is relevant to the content data object 314 based on a relevance score (e.g., relevant to the content object 313 within the visual media content segment 312). For example, where the content data object 314 includes non-image data, such as a text-based description such as a content object identifier or the like, the text-based description may be applied to a lookup table comprising previously stored content data gathered from one or more third-party data sources to identify content data 322 that is relevant to the content data object 314 (e.g., relevant to the content object 313 identified by the content data object 314). In such example embodiments, one or more portions of the content data stored in the content data repository 122 may be associated with a content object identifier or other text-based descriptor that may be used to generate a relevance score for the portion of the content data.

As another example, where the content data object 314 includes image data comprising a spatial segment of a frame of the visual media content, a relevance score may be calculated for each of one or more images stored in the content data repository 122 based on the spatial segment. Image(s) associated with relevance scores that satisfy (e.g., exceeds, equals to, and/or the like) a threshold (e.g., relevance threshold) may be selected and ranked. In some embodiments, the top N ranked images (e.g., N=1, 3, 6, or the like) and/or data associated with the top N ranked images may be input into the machine learning relevance model 120 to output the relevance data object 316 based on analysis of the top N ranked images (e.g., N=1, 3, 6, or the like) and/or data associated with the top N ranked images with one or more of the content data 322, user data 324, or contextual data 326.

In some embodiments, the relevance apparatus (e.g., via the relevance data object generation process) and/or the extraction apparatus (e.g., the content data object generation process) may first execute an image recognition algorithm on the image data comprising a spatial segment of a frame of the visual media content. In such embodiments, the image recognition algorithm may return one or more non-image outputs (e.g., text-based descriptions, including content object identifiers) which may then be fed into the machine learning relevance model 120 or the portion of the machine learning relevance model that generates a relevance score and/or the relevance data object.

In some embodiments, as described above with reference to FIG. 1, the relevance apparatus 110 may be configured to generate the relevance data object 316.

In some embodiments, the relevance data object 316 may be displayed to a user. For example, the relevance apparatus 110 may cause at least one user device to display the relevance data object 316. The at least one user device may include the user device(s) that received the user interaction or may be a different device (e.g., a user device accessing a user email account or application). For example, the relevance data object 316 may be displayed, for example, via a display 328 associated with a user device which may or may not include the user device 306 that generated the segment selection Indication 304. In some embodiments, the relevance data object 316 may be displayed concurrent with rendering of the visual media content on one or more user devices. For example, the relevance data object 316 may be displayed via a display 328 rendering the visual media content while the visual media content is streaming/playing (e.g., in an overlay, split-screen, and/or picture-in-picture mode). Alternatively or additionally, in some embodiments, the relevance data object 316 may be displayed via a first display 328 of a first user device while the visual media content is streaming/playing on a second user device. For example, the relevance data object 316 may be displayed via a display of a user device that is not rendering the visual media content. Alternatively or additionally, the relevance data object 316 may be displayed simultaneously on two or more user devices. In some embodiments, the relevance data object 316 may be delivered independent of the visual media content (e.g., after the visual media content is complete or to a user accessible account that may be retrieved later) or concurrent with the visual media content. It would be appreciated that in some embodiments, display of the relevance data object 316 may not depend on rendering of the visual media content.

In some embodiments, as described above with reference to FIG. 1, the relevance apparatus 110 may be configured to cause display of the relevance data object 316 to a user.

### Example Methods

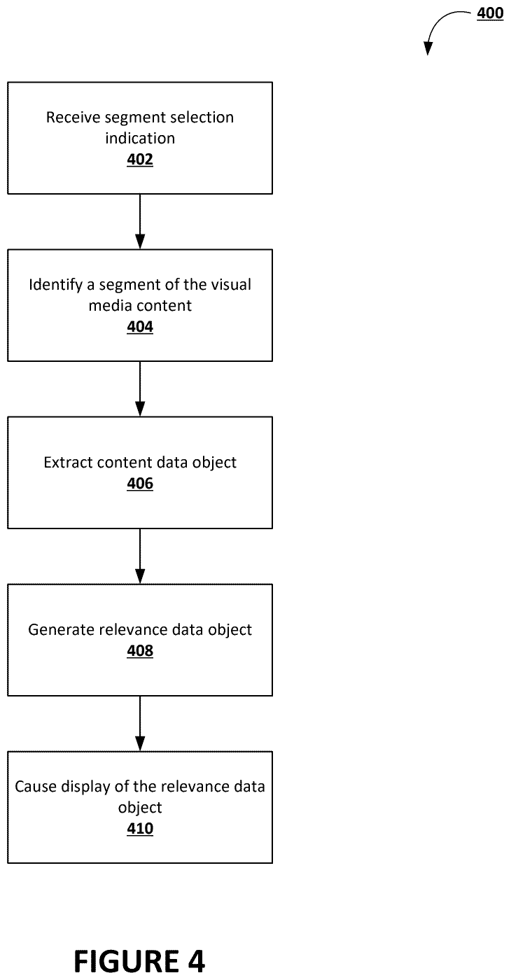

FIG. 4 illustrates an example flowchart depicting operations for dynamic content extraction in accordance with at least some example embodiments of the present disclosure. As depicted at block 402, the process 400 begins with receiving a segment selection indication associated with visual media content. The visual media content segment may include a visual representation or other data indicative of one or more content objects indicated by the user. For example, the extraction apparatus 108 may receive a segment selection indication from a segment selection generator 104, which could comprise one or more user devices, in response user interaction with the segment selection generator 104.

At block 404, the process continues with identifying a segment of the visual media content (e.g., visual media content segment). For example, the extraction apparatus 108 may identify a segment of the visual media content based on the temporal indicator associated with the visual media content and/or spatial segment indicator associated with the visual media content as described above with reference to FIGS. 1 and 3.

At block 406, the process continues with extracting a content data object from at least one portion of the visual media content segment. The content data object may be extracted using any of a variety of extraction techniques. In some examples, the content data object includes one or more content object identifiers that each identify a content object visually rendered in the visual media content (e.g., within the visual media content segment) or other text-based descriptions for the one or more visually rendered content object in the visual media content (e.g., within the visual media content segment). Alternatively or additionally, the content data object includes image data (e.g., image of a region of the frame comprising the visually rendered content object/image of the visual media content segment, image of the content object visually rendered within the visual media content segment, or the like).

At block 408, the process continues with generating a relevance data object. For example, the relevance apparatus 110 may generate a relevance data object based at least in part on the content data object. In some embodiments, generating the relevance data object includes analyzing the content data object based on content data retrieved from a content repository (e.g., content data repository 122) and one or more of user data (e.g., retrieved from a user data repository 124), and/or contextual data retrieved from a contextual data repository 126, The relevance data object may be generated using any of a variety of techniques including, but not limited, to image or other data matching algorithms, machine learning techniques, etc. as described above.

At block 410, the process continues with causing display of the relevance data object to a user. For example, the relevance data object may be displayed to a user via display(s) of one or more user devices.

### Example Implementation

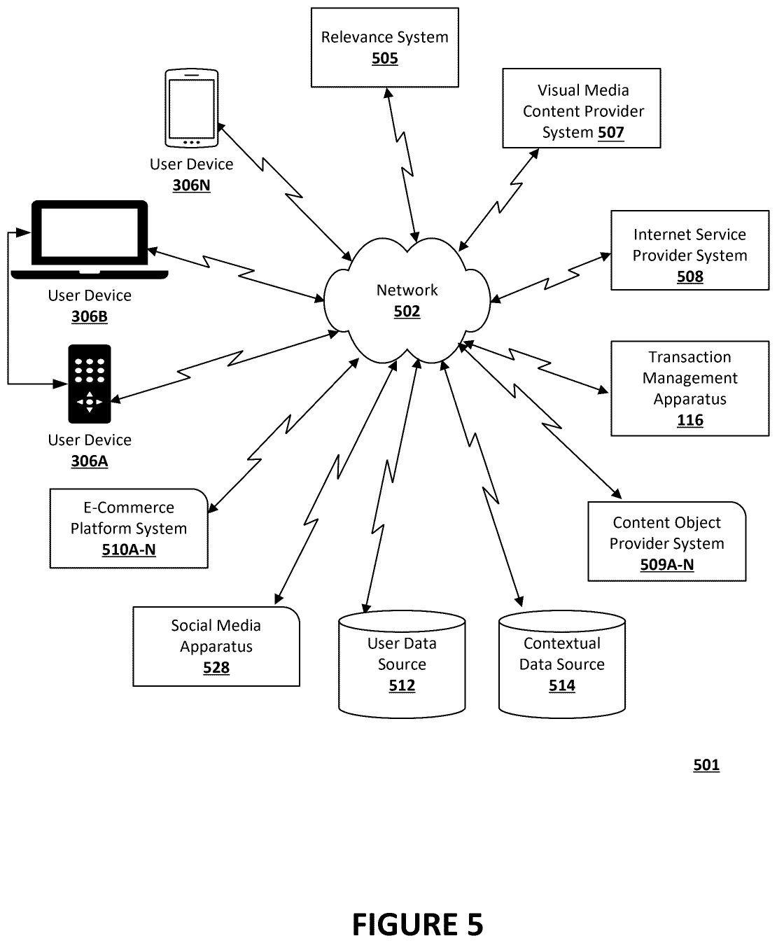

FIG. 5 illustrates an example network architecture for an example implementation of a dynamic content extraction system in accordance with at least some embodiments of the present disclosure. Specifically, FIG. 5 shows a dynamic content extraction system 501, which is an example implementation of the dynamic content extraction system 101 described above. In the illustrated embodiment, the dynamic content extraction system 501 is embodied as a plurality of systems and/or apparatus(es) configured to communicate via network 502. In the example embodiment illustrated in FIG. 5, the dynamic content extraction system 501 includes a relevance system 505, visual media content provider system 507, an internet service provider system 508, and/or a transaction management apparatus 116. In the depicted embodiment, these systems and apparatuses may be configured to, in whole or in part, perform various functions of the dynamic content extraction system 101 shown and described in FIG. 1.

The relevance system 505, visual media content provider system 507, and/or an internet service provider system 508 may be configured to perform the functions of the extraction apparatus 108, relevance apparatus 110, and/or content aggregation apparatus 114. For example, one or more of the relevance system 505, visual media content provider system 507, and/or an internet service provider system 508 may perform the various functions of the extraction apparatus 108; one or more of the relevance system 505, visual media content provider system 507, and/or an internet service provider system 508 may perform the various functions of the relevance apparatus 110; and/or one or more of the relevance system 505, visual media content provider system 507, and/or an internet service provider system 508 may perform the various functions of the content aggregation apparatus 114.

In the illustrated embodiment, the segment selection generator 104 is embodied as one or more user devices 306A-306N. Further, in the illustrated embodiment of FIG. 5, the third-party data source system(s) 106 include one or more content object provider systems 509A-N and/or one or more e-commerce platform systems 510A-N. In some embodiments, the third-party data source system(s) 106 may also include one or more user data sources 512, one or more contextual data sources 514, and/or one or more social media apparatuses 528.

The various components illustrated in FIG. 5 may be configured to communicate via one or more communication mechanisms (e.g., network 502), including wired or wireless connections, such as over a network, bus, or similar connection. For example, network 502 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network 502 may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols. In some embodiments, one or more APIs may be leveraged to communicate with and/or facilitate communication between one or more of the components illustrated in FIG. 5.

FIG. 6 illustrates an example illustration of an arrangement of the example system implementation illustrated in FIG. 5 in the context of the systems, apparatuses, and processes described with respect to FIG. 1. As depicted in FIG. 6, a segment selection indication 304 may be generated by user device 306B in response to a signal received from user device 306A. For example, user device 306A may be configured to transmit a signal to user device 306B in response to user interaction 302 with the user device 306B via user device 306A. By way of example, user device 306A may be an IR-based remote control, RF-based remote control, Bluetooth-based remote control, a mouse, a stylus, or the like and user device 306B may be a television, a laptop, a tablet, or the like and/or a set-top box connected to a television, a laptop, a tablet, or the like. As discussed elsewhere herein, the segment selection generator 104 may comprise other combinations and configurations of one or more user devices.

For example, a user watching visual media content, such as streaming content of an episode a television series, on a display of a television or other user device (e.g., a smartphone, laptop, tablet, or the like) may come across a character wearing a jacket or having an accessory that the user likes and would like to obtain relevant information about (e.g., relevant data object). Via the dynamic content extraction process described herein, the user can, in real-time, access information about content object(s) (e.g., objects or other displayed features, including products such as a piece of clothing, shoe, etc.) visually rendered on the display (e.g., screen or the like) by interacting with the display (e.g., by clicking on the visual representation of the content object of interest to the user) directly (e.g., via touchscreen, voice command, etc.) or using another user device (e.g., via an IR-remote, smart connected device, set-top box, smartphone, and/or other user device). By way of example, in response to the user interaction via the IR-remote, the IR-remote may transmit a signal to the user device which, in turn, generates and transmits a segment selection indication corresponding to the user's interaction (e.g., selection/indications of content object visually rendered in the visual media content). For example, a smart television may comprise circuitry and software configured to determine a location of the display towards which a second user device (e.g., a remote control) is pointed (e.g., such as is used to render a cursor at a particular location on the screen). The coordinates (e.g., X-Y coordinates) associated with the location towards which the remote control is pointed may be used to form a spatial indicator of the segment selection indication while a frame number, scene number, and/or time stamp may form a temporal indicator of the segment selection indication.

In some embodiments, the dynamic content extraction process described herein may allow for the user to switch the interaction to another user device (e.g., from the television to a connected smart device such as a smartphone) or continue interaction with the display concurrently with the streaming of the visual media content or while the visual media content is paused. For example, the relevance data object may be transmitted back to a second user device (e.g., smartphone, tablet, etc.) while the visual media content continues uninterrupted on the display of a first user device. In another example, the second user device (e.g., the device with which the user interacts to provide the user interaction) may, itself, generate the segment selection indication, such as by taking a picture, capturing a screenshot via transferred image from the visual media content, and/or receiving other data from the first user device.

As further depicted in FIG. 6, the segment selection indication 304 may be received by a visual media content provider system 507 and/or an internet service provider system 508. As shown in FIG. 6, the visual media content provider system 507 and/or internet service provider system 508 may comprise or otherwise be configured to perform the functions of the extraction apparatus 108 (e.g., the extraction apparatus also shown and described with respect to FIG. 1). In this regard, the visual media content provider system 507 or the internet service provider system 508 alone or together may perform one or more functions of the dynamic context extraction process as described herein associated with the extraction apparatus 108 (as described above with reference to FIGS. 1 and 3).

In some embodiments, the visual media content provider system may generate and/or deliver the visual media content to the user device(s) 306A-306B. The visual media content provider system 507 may, in some embodiments, generate and/or store one or more of the data sets used for generating the segment selection indication (e.g., prepopulating a database with frame identifiers and content objects associated with each frame), including any data associated with or related to the visual media content and/or content objects identified or identifiable therein. In some embodiments, the internet service provider system 508 may provide internet or other connectivity to the user device(s) 306A-306B for the delivery of the visual media content to the user devices and/or receipt of the segment selection indication therefrom. In some embodiments, the internet service provider system 508 may additionally or alternatively generate and/or store one or more of the data sets used for generating the segment selection indication (e.g., prepopulating a database with frame identifiers and content objects associated with each frame), including any data associated with or related to the visual media content and/or content objects identified or identifiable therein. In some embodiments, only one of the visual media content provider system 507 and the internet service provider system 508 may be used in the dynamic content extraction system 501.

The visual media content provider system 507 and/or the internet service provider system 508 may extract content data object 314 from at least a portion of a segment of the visual media content (e.g., visual media content segment) in response to receiving the segment selection indication 304 and using one or more of a variety of extraction techniques as described herein (e.g., with reference to FIGS. 1 and 3). For example, as described above, the content data object may include text-based description (e.g., content object identifier) associated with the content object selected by the user, such as a visually rendered content object or an image thereof extracted from a segment of the visual media content (e.g., extracted from the current frame of the visual media content displayed on the user device at the time of receiving the user interaction 302). As described above, in an example embodiment, in the event that the segment of the visual media content (e.g., scene and/or frame) selected by the user includes two or more visually rendered content objects, a user interface (e.g., a menu) may be provided to the user to specify which of the visually rendered content objects are of interest to the user.

In some embodiments, the visual media content provider system 507 and/or the internet service provider system 508 may first identify a segment of the visual media content (e.g., visual media content segment 312 as described with reference to FIG. 3) based on a temporal indicator and/or spatial segment indicator associated with the segment selection indication 304.

As depicted in FIG. 6, the visual media content provider system 507 may provide the content data object 314 to the relevance system 505, which may include a machine learning relevance model 120 or other application capable of generating a relevance data object based on the content data object. Specifically, the relevance system 505 may comprise or otherwise be configured to perform the functions of the relevance apparatus 110, whereby the relevance system 505 may receive the content data object 314 via the relevance apparatus 110 as described above. In some embodiments, the relevance system 505 may leverage the machine learning relevance model 120 to generate the relevance data object 316 based on the content data object 314, content data 322 (e.g., stored data associated with one or more content objects, which may include content object identifiers and/or metadata associated with content objects, such as price, promotions, closest retail location, e-commerce channels, etc.), user data 324 (e.g., user purchase history, user preferences, user location, etc.), and/or contextual data 326 (e.g., social media trends, favorite celebrities that have used the content object selected by the user, social media friends that have previously indicated interest in the visually rendered content object selected by the user, etc.). The relevance system 505, via the relevance apparatus 110 and/or the machine learning relevance model 120 may be configured to adapt relevance data objects (e.g., offers, prompts, graphical user interface elements, or the like) based at least in part on the user data 324. The relevance system 505, via the relevance apparatus 110 and/or the machine learning relevance model 120 may be configured to adapt relevance data objects based at least in part on the contextual data 326 which, as described above, may include consumer behavior, industry trends, social media engines feeds, and/or other information streams.

As depicted in FIG. 6, the relevance system 505 may comprise or otherwise be configured to perform the functions of the content aggregation apparatus 114. In this regard, the relevance system 505 (e.g., via the content aggregation apparatus 114) may allow for the content object provider system 509A-N and/or e-commerce platform systems 510A-N to store and update content data associated with the content object provider system 509A-N or the e-commerce platform systems 510A-N in the content data repository 122. In some embodiments, each of the content object provider systems 509A-N may be associated with a designated portion of the content data repository 122, wherein each of the content object provider systems 509A-N may access only the designated portion of the content data repository associated or otherwise assigned to the respective content object provider system. In some embodiments, the content aggregation apparatus 114 may facilitate aggregation of data associated with content objects configured to be included in relevance data objects. Such aggregation may include facilitating matching of one or more of the aggregated content objects with the content data object as described herein. In some embodiments, the aggregation may include pruning or otherwise removing content objects from the content data repository 122 in addition to or instead of collecting new content objects. In some embodiments, the content object provider systems 509A-509N may update various content objects and information associated therewith in the content data repository 122 on demand and/or in real time.

In some embodiments, as shown in FIG. 6, user data stored in the user data repository 124 may be obtained from a user data source 512. In some embodiments, as shown in FIG. 6, contextual data stored in the contextual data repository 126 may be obtained from a contextual data source 514. In some embodiments, the user data source 512 and/or the contextual data source 514 may include third-party data sources. For example, the user data source 512 and/or the contextual data source 514 may be associated with third-party data systems, such as one or more social media apparatuses 528. In some embodiments, user data received from the user data source 512 and/or contextual data received from the contextual data source 514 may originate from a social media apparatus 528 as shown in FIG. 6.

The relevance system 505 may cause display of the relevance data object 316 to a user. For example, the relevance system 505 may transmit the relevance data object 316 to the visual media content provider system 507 and/or internet service provider system 508, which in turn may provide the relevance data object 316 to a user via display of one or more user devices. In some embodiments, the relevance system 505 may transmit the relevance data object directly to one or more user devices (including via a network such as the internet) or via another intermediary system or device.

As depicted in FIG. 6, the transaction management apparatus 116 may be configured to initiate, facilitate, track, and/or manage transaction reconciliation (e.g., periodic financial reconciliation or the like) between and/or among the visual media content provider system 507, the internet service provider system 508, the one or more content object provider systems 509A-N and/or the one or more e-commerce platform systems 510A-N. For example, the transaction management apparatus 116 may be, directly or indirectly, communicatively coupled to the visual media content provider system 507, the internet service provider system 508, the one or more content object provider systems 509A-N and/or one or more e-commerce platform systems 510A-N. In some embodiments, the visual media content provider system 507 and/or the internet service provider system 508 may comprise or otherwise be configured to perform the functions of the transaction management apparatus 116. In some embodiments, the transaction management apparatus 116 may comprise an API or other communication mechanism. In some embodiments, the transaction management apparatus 116 may track, control, or otherwise be associated with the management of the content data repository 122 and the content objects and related data therein (e.g., as provided by one or more third party data source systems 106).

In some examples, the dynamic content extraction system 501 may provide for the user to perform one or more transactions. For example, the dynamic content extraction system (e.g., via the transaction management apparatus 116) may be communicatively coupled to the one or more e-commerce platform systems 510A-N in a manner that enables a user to perform the one or more transactions (e.g., purchasing a content object corresponding to a visually rendered content object in visual media content) based on the relevance data object 316. For example, in some embodiments, one or more provider systems (e.g., visual media content provider system 507 and/or internet service provider system 508) may work with the content object provider system(s) 509A-509N to create transactions that deliver content object provider system content object information (e.g., via relevance data objects) to the user in a contextually relevant manner. In some embodiments, the transaction management apparatus 116 and/or e-commerce platform systems 510A-510N may facilitate such transactions.

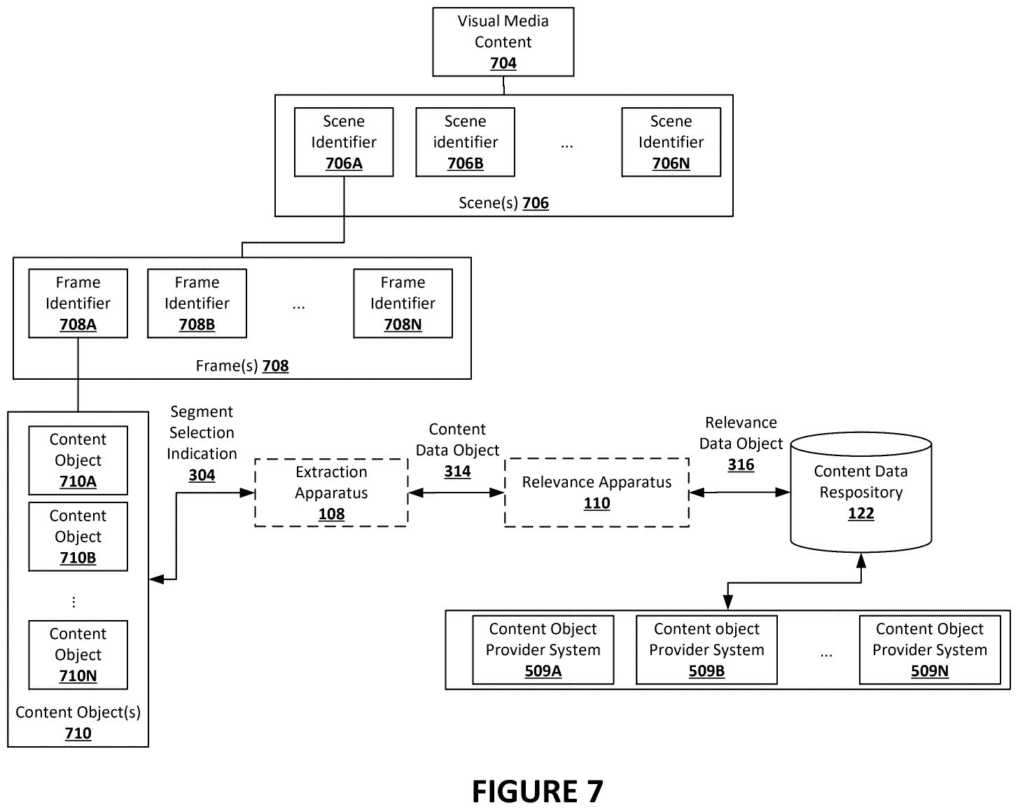

FIG. 7 illustrates a block diagram of an example flow related to extracting content data objects in accordance with at least some embodiments of the present disclosure. For example, FIG. 7 illustrates how a visual media content 704 may be analyzed to generate the segment selection indication 304, content data object 314, and/or relevance data object 316 according to various embodiments disclosed herein (e.g., as described in connection with FIGS. 1, 3, 4, and 6). As shown in FIG. 7, the visual media content 704 may be broken into scenes 706 with each scene associated with a scene identifier 706A-N or other data that may be leveraged to identify a scene.

As shown in FIG. 7, a scene may be broken into one or more frames with each frame associated with a frame identifier 708A-N or other data that may be leveraged to identify a frame. With continued reference to FIG. 7, a frame may include visual representations of one or more content objects 710A-710N in the frame. In some embodiments, a segment selection indication 304 corresponding to a user input/selection may be generated based on user interaction with a display. In the depicted embodiment, a temporal indicator comprising a frame 708A may be identified as part of the segment selection indication in response to the user interaction. For example, the time of the user interaction may match a time that the frame 708A of the visual media content 704 was rendered on the display of the user device, which may identify the frame for dynamic content extraction in response to the user interaction. In some embodiments, a spatial segment indicator of the segment selection indication 304 may be generated (e.g., by a user device) by mapping the location of user interaction with the display (e.g., mapping the location of a cursor on the display via location coordinates or mapping the intersection of a remote control signal, such as a laser or IR signal, with a point or region on the screen). It will be appreciated that visual media content may be configured to adjust to display/screen size and resolution, whereby a region, pixel, or the like on the display/screen clicked on by a user via one or more user devices may be identified.

The segment selection indication 304 may be transmitted to the extraction apparatus 108 configured to extract content data object 314 from a portion of a segment of the visual media content 704 and transmit the content data object 314 to the relevance apparatus 110. The relevance apparatus 110, as described above, may be configured to generate the relevance data object based at least in part on the content data stored in the content data repository 122 which may be accessible to one or more content object provider systems 509A-N to update the content data repository 122.

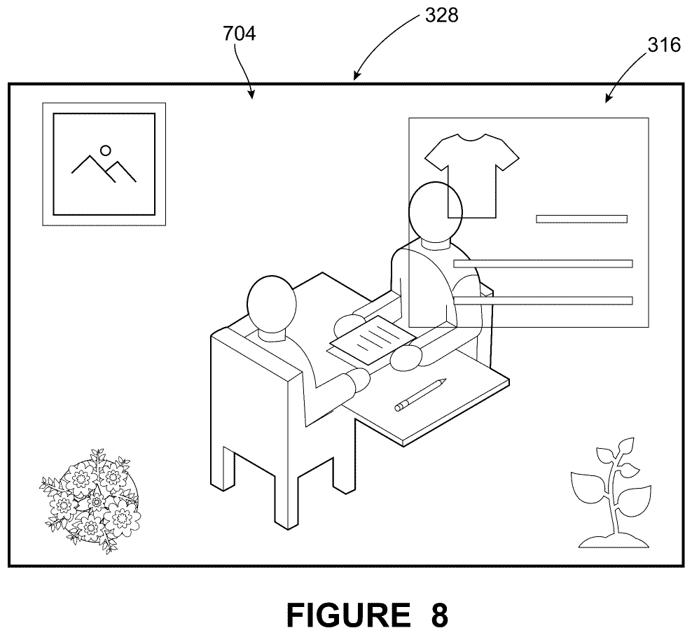

FIG. 8 illustrates an operational example of a relevance data object displayed on a display in accordance with at least some embodiments of the present disclosure. As depicted in FIG. 8, a relevance data object 316 comprising contextually relevant data may be rendered on a user device via a display 328 in response to the user interaction and generation of the segment selection indication. In the depicted example, the relevance data object 316 is rendered on the same display 328 rendering the visual media content 704. For example, the depicted relevance data object 316 is rendered as an overlay that does not require interruption of the underlying visual media content 704. It would be appreciated that in other examples, the relevance data object 316 may be rendered on a display 328 of a user device that is not being used to render the relevance data object or that is not capable of rendering the relevance data object 316 or may otherwise be presented to the user.

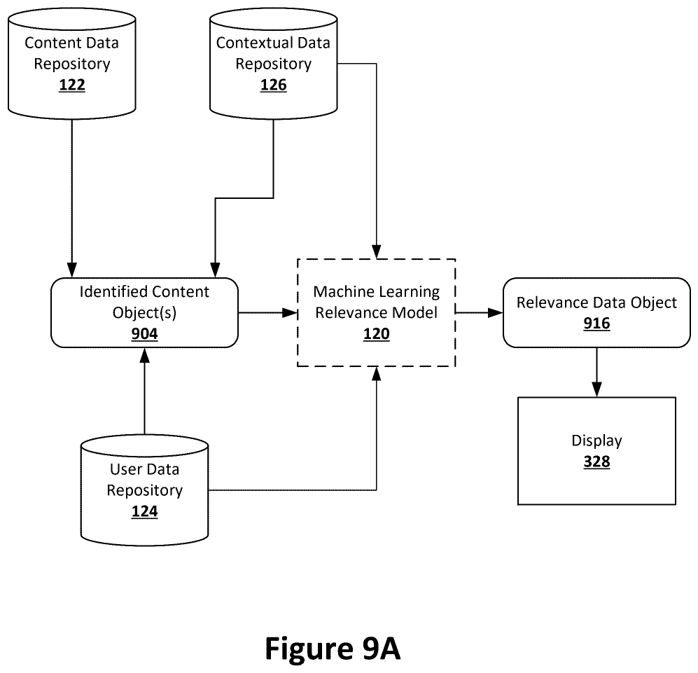

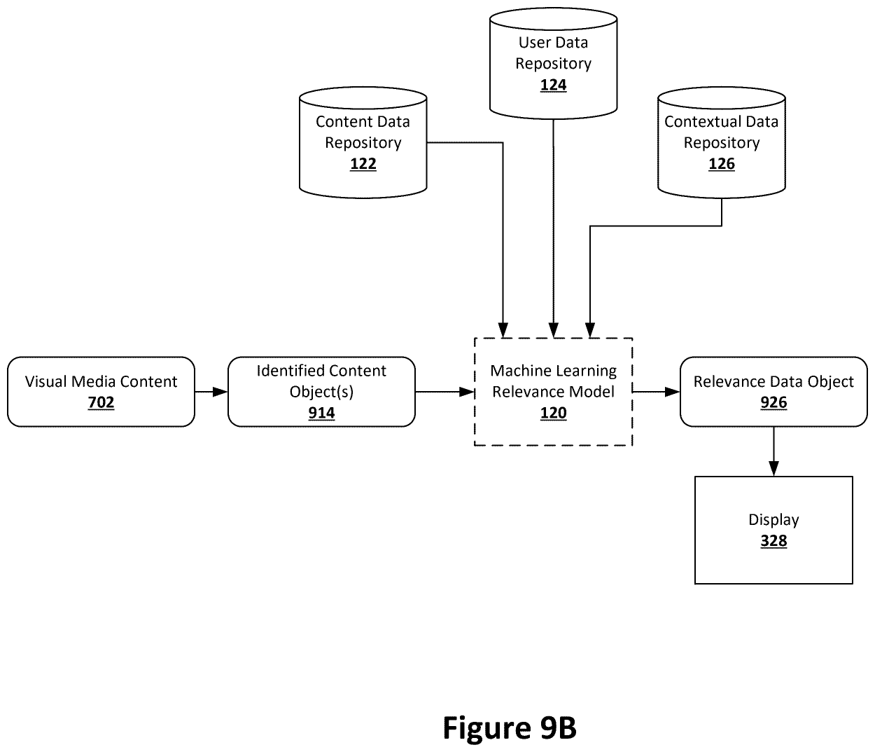

FIG. 9A is an alternative example data flow diagram showing example data structures for dynamic content extraction in visual media content in accordance with at least some embodiments of the present disclosure. In the illustrated embodiment of FIG. 9A, the dynamic content extraction system, such as via the extraction apparatus (e.g., extraction apparatus 108 shown in FIG. 1) and/or relevance apparatus (e.g., relevance apparatus 110 shown in FIG. 1), is configured to identify a content object 904 relevant to a user (e.g., independent of and/or prior to display of the content object on the visual media content) and may analyze the identified content object 904 (e.g., a text-based representation and/or or an image based representation of the content object) to generate a relevance data object 916. The dynamic content extraction system may, for example, identify the content object 904 based on data stored in the content data repository 122, user data repository 124, or contextual data repository 126. Such data may include user's prior interests, purchase history, social media friends that have purchased or shown interest in the content object 904, or the like. In some embodiments, the machine learning relevance model 120 or another machine learning model or other application or algorithm may be configured to identify the identified content object(s) 904.

In the illustrated example embodiment of FIG. 9A, the dynamic content extraction system may be configured to generate a relevance data object 916 based on or in anticipation of a content object visually rendered in a visual media content being currently streamed/watched by the user, scheduled to be streamed/watched by the user, frequently streamed/watched by the user, or the like. For example, the extraction apparatus 108 may be configured to match the identified content object 904 to a content object visually rendered in visual media content (e.g., via monitoring current or future visual media content associated with a user or user device). The dynamic content extraction system may leverage the machine learning relevance model 120 to generate the relevance data object 916. The dynamic content extraction system may be configured to cause the relevance data object to be displayed on a display 328 of a user device. The process described and shown with respect to FIG. 9A may or may not require an initial user interaction.

FIG. 9B is another alternative example data flow diagram showing example data structures for dynamic content extraction in visual media content in accordance with at least some embodiments of the present disclosure. In the illustrated example embodiment of FIG. 9B, the dynamic content extraction system, such as via an extraction apparatus (e.g., extraction apparatus 108) and/or a relevance apparatus (e.g., relevance apparatus 110) may be configured to identify visual media content 702 associated with a user and analyze the visual media content or a portion thereof (e.g., a scene) for one or more temporal indicators and/or spatial indicators comprising content objects relevant to a user. The visual media content may be analyzed during, prior to, or after presentation of the visual media content via a user device, and the process described and shown with respect to FIG. 9B may or may not require an initial user interaction. For example, the dynamic content extraction system may be configured to identify a content object 914 that will be visually rendered in the visual media content 702 and that is or may be relevant to a user using the foregoing processes and generate a relevance data object 926 based on the identified content object 914. The relevance apparatus 110 may cause the relevance data object 926 to be displayed on a display 328 of a user device. The relevance data object 926 may comprise contextually relevant data with respect to the identified content object 904.

FIG. 10 illustrates an operational example of initiating a dynamic content extraction process in accordance with at least some embodiments of the present disclosure. Specifically, FIG. 10 illustrates an operational example of a user interaction for generating a segment selection indication via one or more user devices. As depicted in FIG. 10, a segment selection indication 304 may be generated in response to user interaction with a display of a user device 306B via a user device 306A.

### Additional Examples and Embodiments

In some embodiments, one or more artificial intelligence (e.g., machine learning models) may be leveraged to extract the content data object from at least a portion of the segment of the visual media content corresponding to the segment selection indication. For example, an image of at least a portion of the current frame at the time of segment selection indication may be captured and input to the one or more artificial intelligence/machine learning models to identify the content object of interest.

In some embodiments, the relevance data object may be generated based on events, actions, and/or the like occurring in the visual media content. By way of example, a relevance data object may be generated in response to a scene in the visual media content where a mobile phone visually rendered in the visual media content is damaged, whereby the relevance data object may include contextually relevant data such as mobile phone insurance services, mobile phone diagnostic tools, and/or the like.

In some embodiments, the relevance data object may be generated based on the user's prior interests and/or purchase history. For example, a relevance data object may be generated in response to identifying a content object that is visually rendered in the visual media content stream that is similar to a content object previously purchased by the user or indicated by the user as an object of interest.

In some embodiments, the relevance data object may include a message or notification to the user notifying the user of a content object visually rendered in the visual media content that may be of interest to the user based on, for example, the user's preferences, user's prior purchases, user's purchasing trend, and/or other data that may be leveraged to identify content objects that may be of interest to a user.

In some embodiments, the dynamic content extraction system 101and/or system environment 100 may provide for a user to purchase a content object via or more components of the dynamic content extraction system 101and/or the system environment 100.

In some embodiments, the dynamic content extraction system 101 and/or other portions of the system environment 100 may provide for or facilitate interaction between the visual media content provider system 507 and one or more content object provider systems 509A-N for content object provider systems 509A-N to offer content objects associated with the content object provider systems 509A-N in visual media contents being created by the visual media content provider system 507.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for dynamic content extraction in visual media content, the system comprising one or more processors and at least one non-transitory memory comprising instructions that, with the one or more processors, cause the system to:
receive a segment selection indication associated with visual media content;
identify a segment of the visual media content based on temporal indicator associated with the segment selection indication;
extract a content data object from at least one portion of the segment of the visual media content;
generate a relevance data object based on the content data object; and
cause display of the relevance data object to a user.

2. The system of claim 1, wherein the segment of the visual media content includes a visual representation of a content object.

3. The system of claim 2, wherein the temporal indicator comprises a timestamp associated with the content object visually rendered in the visual media content.

4. The system of claim 2, wherein the segment comprises one or more frames of the visual media content and the temporal indicator comprises a frame identifier associated with the content object visually rendered in the visual media content.

5. The system of claim 2, wherein the content data object comprises a content object identifier for the content object visually rendered in the visual media content.

6. The system of claim 2, wherein the content data object comprises an image of the content object visually rendered in the visual media content.

7. The system of claim 2, wherein extracting the content data object comprises:
capturing an image of the content object visually rendered in the visual media content; and
performing image analysis on the captured image to identify the content object visually rendered in the visual media content.

8. The system of claim 1, wherein the segment selection indication further comprises a spatial segment indicator, and the segment is identified based on the temporal indicator and the spatial segment indicator.

9. The system of claim 1, wherein the relevance data object is generated using a machine learning relevance model analyzing the content data object and contextual data associated with the user.

10. The system of claim 1, wherein the relevance data object is generated using a machine learning relevance model analyzing the content data object and user data.

11. A computer implemented method for dynamic content extraction in visual media content, the method comprising:
receiving a segment selection indication associated with visual media content;
identifying a segment of the visual media content based on temporal indicator associated with the segment selection indication;
extracting a content data object from at least one portion of the segment of the visual media content;
generating a relevance data object based on the content data object; and
causing display of the relevance data object to a user.

12. The method of claim 11, wherein the segment of the visual media content includes a visual representation of a content object.

13. The method of claim 12, wherein the temporal indicator comprises a timestamp associated with the content object visually rendered in the visual media content.

14. The method of claim 12, wherein the segment comprises one or more frames of the visual media content and the temporal indicator comprises a frame identifier associated with the content object visually rendered in the visual media content.

15. The method of claim 12, wherein the content data object comprises a content object identifier for the content object visually rendered in the visual media content.

16. The method of claim 12, wherein the content data object comprises an image of the content object visually rendered in the visual media content.

17. The method of claim 12, wherein extracting the content data object comprises:
capturing an image of the content object visually rendered in the visual media content; and
performing image analysis on the captured image to identify the content object visually rendered in the visual media content.

18. The method of claim 11, wherein the segment selection indication further comprises a spatial segment indicator, and the segment is identified based on the temporal indicator and the spatial segment indicator.

19. The method of claim 11, wherein the relevance data object is generated using a machine learning relevance model analyzing the content data object and contextual data associated with the user.

20. The method of claim 11, wherein the relevance data object is generated using a machine learning relevance model analyzing the content data object and user data.
